(19) United States
(12) Patent Application Publication
(10) Pub. No.: US 2021/0081698 A1
(43) Pub. Date: Mar. 18, 2021

(54) SYSTEMS AND METHODS FOR PHYSICAL OBJECT ANALYSIS

(71) Applicant: Nano TechGalaxy, Inc. D/B/A Galaxy.AI, Cambridge, WA (US)

(72) Inventors: Jacob Cline Lindeman, Amherst, MA (US); Louizos Alexandros Louizos, New York, NY (US)

(21) Appl. No.: 16/968,310

(22) PCT Filed: Feb. 8, 2019
(86) PCT No.: PCT/US2019/017222

§ 371 Date: Aug. 7, 2020

Related U.S. Application Data
(60) Provisional application No. 62/628,400, filed on Feb. 9, 2018.

(51) Int. Cl. G06K 9/32; G06T 7/00; G06T 7/11; G06T 7/70; G06T 3/40; G06N 5/02

(52) U.S. Cl. CPC G06K 9/3241; G06T 7/0006; G06T 7/11; G06T 7/70; G06T 2207/20081; G06N 5/025; G06K 2209/23; G06T 2207/30248; G06T 3/403

(57) ABSTRACT

Disclosed are devices, systems, apparatus, methods, products, and other implementations, including a method that includes obtaining physical object data for a physical object, determining a physical object type based on the obtained physical object data, and determining based on the obtained physical object data, using at least one processor-implemented learning engine, findings data comprising structural deviation data representative of deviation between the obtained physical object data and normal physical object data representative of normal structural conditions for the determined physical object type.

### CROSS-REFERENCE RELATED APPLICATIONS

This application claims the benefit of U.S. Provisional Application No. 62/628,400, filed Feb. 9, 2018 the content of which is herein incorporated by reference in its entirety.

### BACKGROUND

To assess structural anomalies for the structure of a physical object (e.g., damage sustained by a vehicle), visual assessments of the physical object is frequently used. Such assessments are prone to error due inter- and intra-rater variations (e.g., inter-appraiser and intra-appraiser variations), which can reduce precision and accuracy of the assessment.

### SUMMARY

Disclosed are systems, methods, and other implementations to detect features of a physical object, identify a physical object type for the physical object, and determine structural anomalies for the physical object.

In some variations, a method is provided that includes obtaining physical object data for a physical object, determining a physical object type based on the obtained physical object data, and determining based on the obtained physical object data, using at least one processor-implemented learning engine, findings data comprising structural deviation data representative of deviation between the obtained physical object data and normal physical object data representative of normal structural conditions for the determined physical object type.

Embodiments of the method may include at least some of the features described in the present disclosure, including one or more of the following features.

Obtaining physical object data may include capturing image data for the physical object, and determining the physical object type may include identifying, based on the captured image data for the physical object, an image data type from a plurality of pre-determined image data types.

The plurality of pre-determined image data types may include one or more of, for example, a location in which a vehicle is located, an exterior portion of the vehicle, an interior portion of the vehicle, and/or a vehicle identification number (VIN) for the vehicle.

Determining the physical object type may include segmenting, in response to determination that the physical object data corresponds to a captured image of a vehicle, segmenting associated image data from the captured image into one or more regions of interests, and classifying the one or more regions of interest into respective one or more classes of vehicle parts.

Segmenting the associated image data into the one or more regions of interest may include resizing the captured image to produce a resultant image with a smallest of sides of the captured image being set to a pre-assigned size, and other of the sides of the resultant image being re-sized to resultant sizes that maintain, with respect to the pre-assigned size, an aspect ratio associated with the captured image, transforming resultant image data for the re-sized resultant image, based on statistical characteristics of one or more training samples of a learning-engine classifier used to classify the one or more regions of interest, to normalized image data, and segmenting the normalized image data into the one or more regions of interest.

The method may further include classifying, using the learning-engine classifier, the one or more regions of interest in the re-sized resultant image containing the normalized image data into the respective one or more classes of vehicle parts.

Determining the structural deviation data between the captured physical object data and the normal physical object. data may include detecting structural defects, using a structural defect learning-engine, for at least one of the segmented one or more regions of interest.

Detecting the structural defects may include deriving structural defect data, for the structural defects detected for the at least one of the segmented one or more regions of interest, representative of a type of defect and a degree of severity of the defect.

The method may further include determining, based on the determined structural deviation data, hidden damage data representative of one or more hidden defects in the physical object not directly measurable from the captured physical object data. The hidden damage data for at least some of the one or more hidden defects may be associated with a confidence level value representative of the likelihood of existence of the respective one of the one or more hidden defects.

The method may further include deriving, based on the determined structural deviation data, repair data representative of operations to transform the physical object to a state approximating the normal structural conditions for the determined object type.

Deriving the repair data may include configuring a rule-driven decision logic process, and/or may include a data driven probabilistic models or deep learning network classification processes, to determine a repair or replace decision for the physical object based, at least in part, on ground truth output generated by an optimization process applied to at least some of the determined structural deviation data.

The optimization process may include a stochastic gradient descent optimization process.

Obtaining the physical object data for the physical object may include capturing image data of the physical object with one or more cameras providing one or more distinctive views of the physical object.

Determining the physical object type may include identifying one or more features of the physical object from the obtained physical object data, and performing classification processing on the identified one or more features to select the physical object type from a dictionary of a plurality of object types.

The method may further include generating feedback data based on the findings data, the feedback data comprising guidance data used to guide the collection of additional physical object data for the physical object.

Generating the feedback data may generating, based on the findings data, synthetic subject data representative of information completeness levels for one or more portions of the physical objects.

Generating the synthetic subject data may include generating graphical data representative of information completeness levels for the one or more portions of the physical objects, with the graphical data being configured to be rendered in an overlaid configuration on one or more captured images of the physical object to visually indicate the information completeness levels for the one or more portions of the physical object.

The method may further include causing, based at least in part on the feedback data, actuation of a device comprising sensors to capture the additional physical object data for the physical object for at least one portion of the physical object for which a corresponding information completeness level is below a pre-determined reference value.

In some variations, a system is provided that includes an input stage to obtain physical object data for a physical object from one or more data acquisition devices, and a controller, implementing one or more learning engines in communication with a memory device to store programmable instructions, to determine a physical object type based on the obtained physical object data, and determine based on the obtained physical object data, using at least one of the one or more learning engines, findings data comprising structural deviation data representative of deviation between the obtained physical object data and normal physical object data representative of normal structural conditions for the determined physical object type.

In some variations, a non-transitory computer readable media is provided, to store a set of instructions executable on at least one programmable device, to obtain physical object data for a physical object, determine a physical object type based on the obtained physical object data, and determine based on the obtained physical object data, using at least one processor-implemented learning engine, findings data comprising structural deviation data representative of deviation between the obtained physical object data and normal physical object data representative of normal structural conditions for the determined physical object type.

Embodiments of the system and the non-transitory computer readable media may include at least some of the features described in the present disclosure, including at least some of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1A is a schematic diagram of an example system to analyze data obtained for a physical object to determine the structural deviation of the object's structure from normal structural conditions.

FIG. 1B is a block diagram of another example system to analyze data obtained for a physical object, and to determine the structural deviation of the object's structure from normal structural conditions.

FIG. 1C is a block system interaction diagram showing some of the various features and processes implemented for a system configured to analyze data obtained for a physical object.

FIG. 2 is a block diagram of an example analysis system to process physical object data and determine structural deviation therefor.

FIG. 3 is a view of an example report generated by the system of FIG. 2.

FIG. 4 is a flowchart of an example procedure to determine structural anomalies for a physical object.

FIG. 5 is a schematic diagram of an example computing system.

FIG. 6 is an example processed image comprising bounding boxes.

Like reference symbols in the various drawings indicate like elements.

### DESCRIPTION

Described herein are systems implementing a neural network architecture, trained on task specific annotated examples of objects of interest and objects of non-interest, to classify and localize structural abnormalities of the objects. The structural abnormalities determined may be used to generate, in some embodiments, a report of the cost and actions needed to return the objects to normal state. In some embodiments, the derivation of structural abnormalities is based on a function that accepts images as input, in the form of tensors containing the intensity of each channel Blue-Green-Red (BGR). A data array is then generated that contains the number values that represent the physical description of the image object, and the status of the object as to whether it contains structural anomalies or deviations (e.g., damages) or represents normal or optimal structure condition (non-damaged). A combination of neural networks (a combination of customized proprietary networks, VGG and inception kV3 public domain neural networks) is used to produce outputs to populate one or more dictionaries describing the status of the object under assessment. Upon processing all available data (e.g., multiple images of the same object), a complete/final state of processing output can be used to create a final report on the structural state of the object and potential costs for correcting actions. By combining two or more different localization processes, an attention mechanism of visual assessment can be realized. Thus, in some embodiments, methods, systems, devices, and other implementations are provided that include a method comprising obtaining physical object data (e.g., image data from one or more age-capture devices) for a physical object (e.g., a vehicle), determining a physical object type based on the obtained physical object data, and determining based on the obtained physical object data, using at least one processor-implemented learning engine, findings data comprising structural deviation data representative of deviation between the obtained physical object data and normal physical object data representative of normal structural conditions (e.g., optimal or sub-optimal structural conditions, that can be adjusted based on estimated or known age of the object) for the determined physical object type.

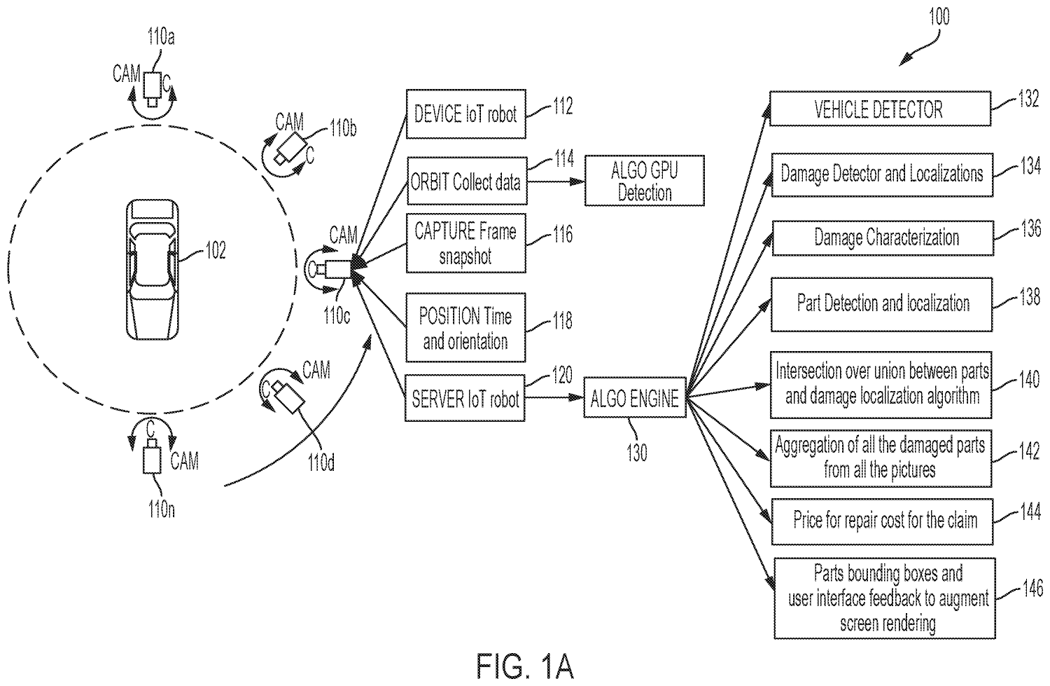

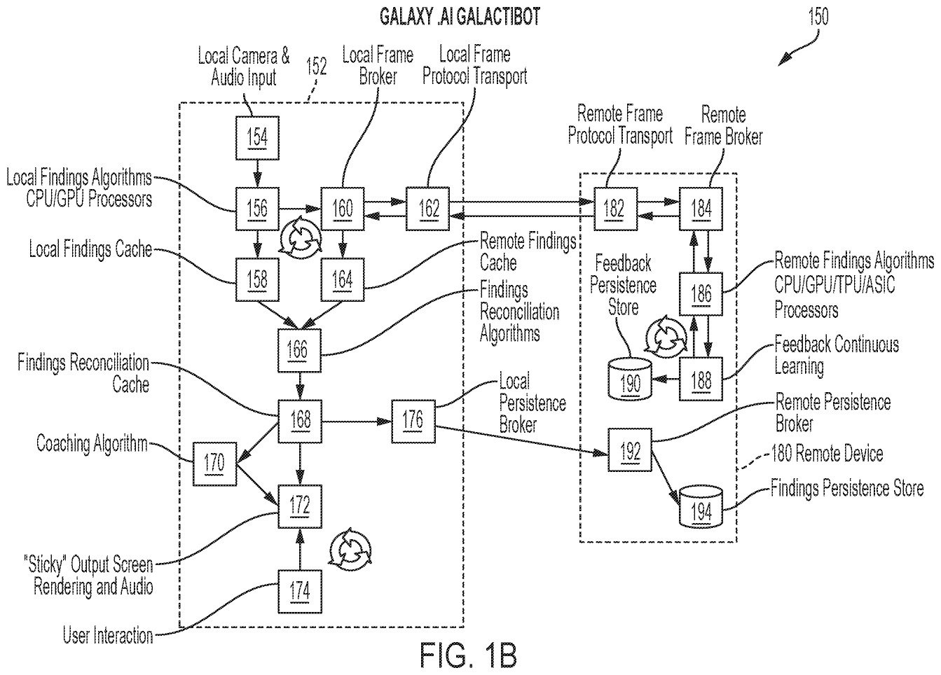

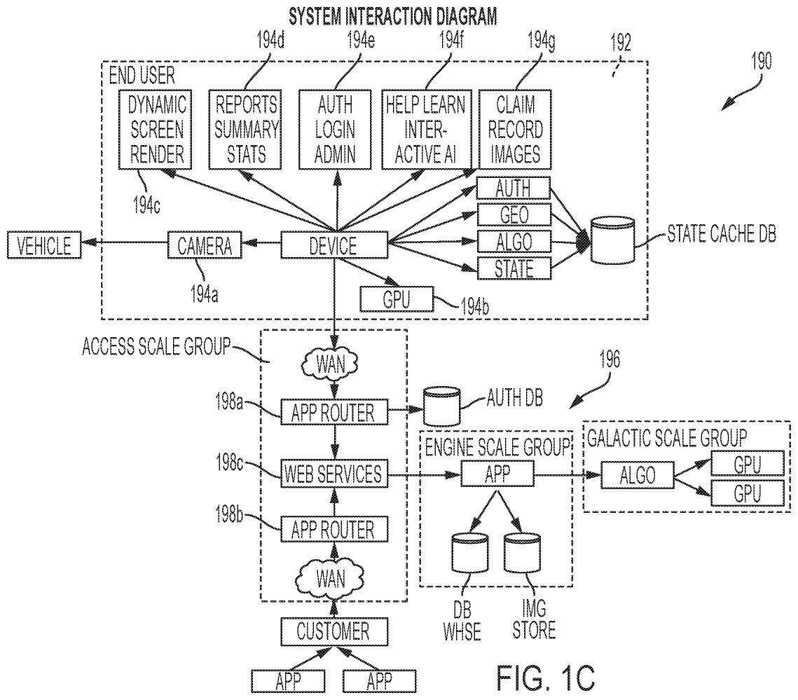

With reference to FIG. 1A, a schematic diagram of an example system 100 to analyze data obtained for a physical object 102 (e.g., a car) to determine the structural deviation of the object's structure from normal (e.g., optimal or sub-optimal) structural conditions. The system 100 includes one or more data acquisition devices, such as the multiple image-capture devices (cameras) 110a-n disposed at different positions and orientations relative to the physical object 102. Thus, the cameras 110a-n can capture image data for the physical object 102 that may not be entirely visible from another of the cameras (for the remainder of the discussion provided herein, reference will be made to the car as the example physical object with respect to which the implementations described herein are used; however, any other physical object may be processed by the implementations described herein). The use of multiple cameras, with different fields of view relative to the object being observed, allows derivation of stereoscopic information from the captured images, based on which distance and depth perception for the object can be computed. This facilitates detection of damage and determination of damage severity for the object in question. Aside from the cameras 110a-n, other types of sensors and data acquisition devices (e.g., audio sensors, ultrasonic transponders to collect ultrasound data about the internal, non-visible, structure of the object, laser scanners to detect abnormalities on the curvature of the object, etc.) may be used to collect physical object data for the car 102. As illustrated in FIG. 1A, the various devices 110a-n are disposed in a semi-circle configuration surrounding an area where the object to be analyzed can be placed.

The cameras 110a-n may each be of the same or of a different type. For example, in some embodiments, the cameras 110a-n may include one or more fixed position cameras such as PTZ (Pan-Tilt-Zoom) cameras. Each of the cameras, such as the camera 110c, may be a smart camera that can be part of a network (wired or wireless) to allow data and control signals to be transmitted to or from the camera 110c to remote devices. For example, the camera 110c may include a controller (e.g., processor-based controller) and/or a communication module to configure and control the camera 110c to be part of an internet-of-things (IoT) network. Control and communication functionality for the camera 110c (and similarly for other data acquisition devices) may be realized via a controller 112 (also referred to, in FIG. 1A, as “IoT Robot”). Thus, the device may receive control signals from a remote server to cause controlled positioning of the camera in order to capture appropriate parts of the data. In some embodiments, the controller 112 may use initial data captured by the camera, to adjust its position/orientation. For example, the controller 112 may be configured to receive an initial capture image of the physical object, to identify some salient features in the image (e.g., the position of the front passenger door of a car, the center of the passenger side of the car, etc.) and to adjust the position of the camera based on identified features and the camera orientation and position relative to those identified features.

As further illustrated in FIG. 1A, the camera 110c may also include a data collection module 114 (marked as “Orbit, Collect Data”) which. may be configured to store data (in a memory storage device or buffer housed within the module). The data, collection module 114 may be further configured to perform some initial processing on stored data (such as pre-processing to filter noise or otherwise clean, normalize, or adjust the stored data) and/or to perform some basic feature detection (e.g., to identify central or salient features of the object based on which object identification may be made, to define the areas of the image occupied by image data corresponding to the object to be analyzed, etc.). The camera 110c also includes an image-/light-capture device (frame snapshot) 116 that may include a charge-coupled device (CCD)-based capture unit, a CMOS-based image sensor, etc., which may produce still or moving images. The capture device may also include optical components (e.g., lenses, polarizers, etc.) to optically filter/process captured light data reflected from the physical object, before the optically filtered data is captured by the capture unit of the image capture device 116. The captured data may then be written to the memory/storage device of the data collection module 114. In some embodiments, the image capture device 116 (which may include control circuitry, such as a processor) and/or the controller 112 or the data collection module 114 may be configured (independently, or in unison with the other modules of the camera) to perform additional processing on captured data, such as, for example, compress the raw video data provided to it by the capture unit of the image capture device into a digital video format, e.g., MPEG, perform calibration operations, etc.

The camera 110c also includes a positioning device 118 configured to determine position information, including the camera's relative position to the physical object, and/or absolute position (in a real-world coordinate system). The camera's absolute position may be determined based, for example, on RF signals (received from remote devices with known locations or from satellite vehicles, based on which the camera's position may be derived, e.g., through multilateration techniques). Additionally, the positioning device 118 may also determine or provide time information, which it may obtain based on internal clock module realized by the positioning device 118, or based on information received or derived from. wireless signals transmitted from remote devices (base stations, servers, access points, satellite vehicles, etc., which are in communication with the camera 110) via one or more of the communication circuitries implemented by one or more of the camera's modules. In some embodiments, the positioning device may also be configured (through generation of control signals) to actuate the device 110c (e.g., to cause it to be repositioned, to zoom in or out, etc.) Such controlling may be done based on feedback data responsive to findings determined by an analysis engine(s) processing data acquired mi the device 110c (or the other acquiring devices).

The camera 110c may also include a server module 120 which may be configured to establish a communication link (wired or wireless) with a remote server that includes one or more learning engines configured to process physical object data collected by sensor devices (in this example, image data collected by the camera 110c) and determine output data that may include data representative of structural deviation of the structure of the physical object 102 from. some base-line (e.g., optimal or normal conditions) structure. Thus, the server module 120 may implement communication functionality (transmitter/receiver functionality), and may be part of one of the other modules of the camera 110c (e.g., the communication circuitry may be included with transceiver circuitry implemented on the controller 112). In some embodiments, at least some of the learning engines' functionalities that will be described below in relation to downstream modules and processes, may be implemented locally at the server module 120 of the camera 110c.

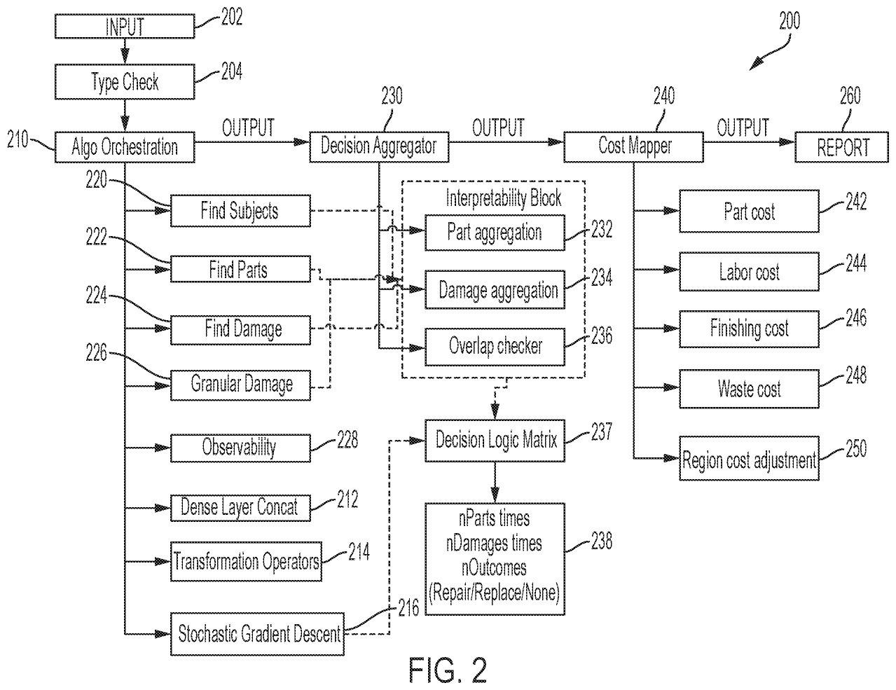

With continued reference to FIG. 1A, data communicated from the camera 110c (and/or from the other data acquisition devices that obtain physical object data pertaining to the structure of the physical object 102) are processed by an analysis engine 130 (also referred to as the “ALGO” engine), which may be realized using one or more learning engines (classifiers, neural nets, and/or other types of learning engine implementations such as a support vector machines (e.g., one implementing a non-linear radial basis function (RBF) kernel), a k-nearest neighbor procedure, a tensor density procedure, a hidden Markov model procedure, etc.) As will be discussed in greater detail below, the engine 130 is configured to implement multiple processes as part of the procedure to determine structural anomalies (e.g., structural deviation) of the physical object being analyzed from normal structural conditions for the object type corresponding to the physical object 102. In doing so, the engine 130 implements multiple learning engines that can independently (or in some cases, may operate sequentially to use some output of one or more of the other learning engines) detect features pertaining to the object being analyzed, with those features represented as regions of interest (e.g., via generated coordinates and/or bounding boxes), and semantic descriptions of the features detected and extracted (e.g., identified parts of the object, descriptions of structural anomalies, etc.) The outputs produced from the dense or other layers (e.g., from processes 220-228 depicted in FIG. 2) are combined at the process 212 (e.g., concatenated 5 rows×256 columns) to generate, at the process 214, input on a cascade of matrix operations (e.g. convolutions and pooling) that start with the input of 212 and transform the input matrix to the decision matrix dimensions while employing at the end of the transformations an optimization process 216 using stochastic gradient descent. The output of the optimization process 216 may include, in some implementation, ground truth output for use by a decision logic matrix. The decision matrix may be a three-dimensional matrix with dimension of A, where A equals the absolute number of parts, B, where B is the absolute number of the type of damages for each part, and C, where C equals a decision for repair/replace/do nothing for each part with potential damage or lack of it. The decision and analysis layer can be used, in some embodiments (e.g., in situations where potentially damaged cars are being analyzed) to produce reports regarding likely structural anomalies detected, corrective/mitigating actions to remedy the anomalies, cost estimates (e.g., in terms of resources to use, or in terms of monetary costs) for undertaking the corrective/mitigating actions, etc.

Thus, for example, the engine 130 may include one or more of the following units/modules:
A) a vehicle detector 132, which implements a process to analyze one or more received images, and to identify an object in the one or more image (e.g., based on image processing, or learning engine processing). For example, an object may be identified based on morphological characteristics, and/or other characteristics that can he detected from the captured images. Alternatively, a learning engine (a neural network) can receive an image and classify the content to one of several pre-determined object types that the learning engine was trained to recognize.
B) A damage detector and localization module 134 and damage characteristics module 136, which together implement (e.g., based on a learning engine implementations) a procedure to analyzes an image to ascertain the presence of a deformation or abnormality in the object of interest, and, using a neural network architecture, performs localization and granular characterization of damages for the object undergoing assessment.
C) Part detection and localization module 140, which is configured to identify (isolate) discrete parts of the object being analyzed (such analysis may be combined with the analysis performed by the damage detector and damage characteristics modules 134 and 136). As will be discussed in greater detail below, in some embodiments, the module 140 may be configured to perform resizing and transformation operations on the image data. The transformed image data may be passed to a region proposal network (e.g., to identify regions of interest that may correspond to different discrete parts of the object). The region proposals may be passed to a fast R-CNN classifier network to determine which object parts are present. The integration of the region proposal and classifier networks may be realized by leveraging the faster R-CNN architecture with Resnet110 base architecture.
D) Aggregation module 142, which is configured to aggregate output data produced for individual data sets, including to aggregate all the damaged parts detected from the various physical object data sources (i.e., multiple images from the multiple cameras 110a-n).
E) Price calculator 144, which is configured to derive an estimate of the cost to restore the damaged structure of the physical object to a more normal structural state.
F) Interface 146, which is configured, among other functions, to provide reports and to graphically render (e.g., on output images that are based on the input images) information germane to the analysis performed, and to allow user interface feedback to augment screen rendering.

Accordingly, in some embodiments, photographic images, photometry, radiometry, luminance and textual data are captured from one or more devices (such as the cameras 110a-n), and transmitted to a server implementing one or more specialized machine learning engines. The machine learning engines process one or more of the captured sets of data (e.g., images) to analyze the subject characteristics (e.g., via the module 132) The results of the analysis include Subject parts detection (produced by the module 132), damage levels (produced by the modules 134 and 136 of FIG. 1A), repair costs (produced by the module 144), identification and accuracy confidence levels and visual bounding boxes for parts and damage area highlights (as performed by the module 146). In some embodiments, the engine 130 may also be configured to control the data acquisition devices. For example, if a computed confidence level for a derived output is below some reference threshold value, the engine 130 may send a request to one of the data acquisition devices (e.g., one or more of the cameras 110a-n) to obtain another data capture (another image) at a higher resolution or zoom, or from a different view or perspective. Multiple processes are thus implemented to work in concert to generate results. Specific processes are developed to solve each of the feature identification requirements. An assembly of the features described herein may be termed the awareness context.

As noted, in some embodiments, the processes are realized using learning engines trained from subject images and data history that includes multiple images representing different damaged parts, claims estimate and final claim processing result reports (including such information as detailed breakdown of parts, labor, region localization, etc., captured during the assessment adjustment process). An awareness state engine is generated during the multi-step multi-part process. Features are gathered as a collection of significant attributes.

In some implementations, a simulated 3D view of the physical object (be it a vehicle, or any other physical object whose physical structure is to be analyzed to determine deviation of the structure from a baseline or normal conditions of the structure) is generated from data captures. The view can be manipulated by the user to zoom, pan, rotate and study the state collection. Feature collections may be controlled according to the characteristics for which data is being and collected and confidence levels in the measurements (i.e., the collected data), where results are suppressed or revealed based upon thresholds or type masks. Threshold masks are dynamically adjustable and exhibit a “squelching” effect for features to be included or excluded from use by future process steps, from use by screen rendering and display, and from use by an awareness state engine.

In some embodiments, one or more of the data collection devices/sensors may include handheld mobile devices such as cellular phones and tablets. Other embodiments may include flying drones and ground-based drones that probe and collect features in an autonomous or semi-autonomous fashion. The collection of features can define a fingerprint for the physical object to be analyzed. Thus, an early capture of physical object data (using light-capture devices and/or other sensors to capture/measure data relevant to the structure of the physical object) can establish a baseline of data for a particular object. A subsequent re-run of data capture for the physical object can then facilitate a comparative analysis of structure attributes determined from the re-run of the data capture process relative to structural attributes derived from the baseline data. Alternatively, as noted, when no baseline data exists for the particular object, determination of possible deviation of the physical structure of the object from a normal (or optimal) state may be derived using, among other things, trained learning engines and/or other types of classifiers or processes to determine structural attributes of the physical object. The comparative analysis is used for object identification and determination of structural changes (e.g., prior damage versus new damage, with such comparisons being used for fraud detection).

In some embodiments, stereoscopic image data may be used to derive depth data, which can be used to further analyze structural features (including changes or deviations of such data from a baseline or from a normal structural state) in order to identify possible structural damage and derive remediation projections (e.g., devising a repair plan and estimating cost of repairing the structural damage).

As will be discussed in greater detail below, in some variations, image data can be pre-processed into a normalized resolution and color profile format to facilitate use of learning-engine-based tools (which may have been trained using normalized image data). Images can then pass through multiple analysis subroutines including convolution, dropout, contrast, reflectivity and change in gradient. In some embodiments, the output of the system implementations described herein include textual and graphic data that may represent features and structural damage.

With reference to FIG. 1B, a block diagram of another example system 150, which may be similar (at least partly), in its implementation and/or configuration, to the example system 100 of FIG. 1A, to analyze data obtained for a physical object (such as the object 102 of FIG. 1A) to determine the structural deviation of the object's structure from normal (e.g., optimal or sub-optimal) structural conditions. The example system 150 (which is also referred to as the “Galactibot” system) is configured to facilitate feedback-based interaction between a local computing device (which may be similar to the device 110c depicted in FIG. 1A) and a remote analysis system (which may include one or more learning engines, as more particularly described in relation to the analysis engine 130 of FIG. 1A). More particularly, the example system 150 may be implemented, in some embodiments, to perform high level processing at remote servers (such remote servers being in wireless or wired communication with the local computing device), and provide feedback data to the local device to allow the local device to re-direct its acquisition of raw data according to findings determined at the remote servers (e.g., to focus on physical features of the object being analyzed in order to acquire more data in relation to some physical feature). Another example in which the remote computing elements of the system 150 can provide feedback data to the local device is by generating output data presentable to a user handling the local device that provides meaningful information to the user, e.g., to implement augment reality on the output interface, through, for example, rendering of graphical artifacts of a display device to augment or supplant acquired visual data, with such artifacts indicating, is some examples, information completeness levels associated with the remote artifacts and/or the locations where the artifacts are rendered.

As illustrated in FIG. 1B, the system 150 may include two main parts: the local computing device 152, which, as noted, may be similar to any of the devices 110a-n depicted in FIG. 1A, and a remote device 180 which may implement at least some of the functionality implemented by the analysis engine 130 of FIG. 1A (e.g., as described in relation to the modules 132-146 shown in FIG. 1 and as further discussed in relation to FIG. 2). More particularly, the local computing device 152 includes a local camera and audio input unit 154 such as a CMOS-based image sensor or a charge-coupled device, and/or a microphone. The unit 154 may include additional sensor devices, such as inertial/navigational sensors. The local computing device 152 housing the local camera and audio input unit 154 may be a smartphone, or some other mobile device (e.g., any type of an Internet-of-Things, or IoT, device, with communication and sensory capabilities). As noted with respect to the devices 110a-n, the input module 154 may also include optical components (e.g., lenses, filters, etc.) that are structured to perform optical processing on captured light-based data. The input module 154 is configured, for example, to capture images, and can operate in frame streaming mode. The input module is configurable to format/output the captured data into output streams of data at varying rates (e.g., 1 frame/second, 5 frames/second, etc.)

Coupled to the module 154 is processing unit 156 comprising one or more local processors (which may include one or more CPU) and/or one or more graphic processing units (Gal) that apply at least initial intake processing (e.g., pre-processing) on input data captured by the unit 154 and streamed/routed to the processing unit 156. In some embodiments, pre-processing performed by the processing module 156 may include filtering noise, normalizing, or performing various adjustments or transformation on the incoming streamed data (whether the data is image data, or some other type of sensor data). In some examples, the processing unit may also be configured to perform higher level analysis on the data to produce findings that include at least some of the findings produced, for example by the remote device 180 or by the remote servers, implementing processors, learning engines, classifiers, etc., that are similar to those implemented by the analysis engine 130 of FIG. 1A. For example, the processing unit may be configured to determine one or more of: object type for the object for which input data was captured by the module 154, damage detection and determinations representative of detected structural abnormalities in the structure of the object, identification of discrete parts/elements of the object, data aggregation to aggregate findings data, damage estimation representative of the cost (monetary or otherwise) of structural abnormality or damage to the object, etc. The performance of processing to derive findings requiring more intense classification processing may be performed locally based on the resources available at the local device 152 and/or based on the availability of communication resources that can support the assignment of higher-level processing to a remote device. For example, if the local communication module cannot establish (or is inhibited from establishing) a communication channel with sufficient bandwidth, the local device may be configured to perform the higher-level processing to produce at least some of the findings. Local processing may be necessary when communication with a remote device is not available or is too slow, particularly in circumstances where the higher-level findings are required as feedback by the local device to perform, for example, input data acquisition. For example, the findings determined through high-level processing may include augmented reality renderings that can be rendered on a display device of the local device to guide the user on what additional data is needed and where to move the device so that missing data can be obtained. If access to the remote computing device is inhibited, it may become necessary to perform, for example, part identification processing and augmented reality data generation at the local device so that the task performed at the local device and by the user can he completed. In circumstances where the local device 152 performs, via its local processing module 156, at least some high level analysis (e.g., to produce, for example, findings determination, and data derived therefrom), the findings produced can be stored at a local memory dedicated for storing such findings. For example, the locally-determined high-level findings may be stored at a local finding cache 158.

With continued reference to FIG. 1B, input sensor data obtained through the local sensors and subjected to pre-processing via the processing unit 156 may be directed to a local frame broker 160 which may be configured to select (e.g., if communication resources are such that some data culling is required) data frames (e.g., image frames) that are determined to include data that would be more optimal for high-level processing at the remote device. Thus, for example, the local frame broker 160 may discard data that is repetitive/redundant, or that includes non-important data. For instance, the frame broker can keep one out of N image frames captured by a camera of the local device, while discarding all the other frames. Alternatively or additionally, the local frame broker may perform down-sampling operation to reduce the amount of data provided to the remote device and/or to conform the data record size and formatting that are required as input to the processing/analysis engines (e.g., to the various learning or classification engines comprising, for example, the analysis engine 130 of the system 100 depicted in FIG. 1A). In some embodiments, image resolution may he down-sampled on the fly to improve response time. Additionally, the local frame broker 160 may select between available frames (i.e., as to which of two competing frames to discard or keep) based on an initial processing that assesses the data quality and information quality in frames. For example, the local frame broker may include a classification engine configured to recognize artifacts/features that may he deemed to he irrelevant (e.g., body parts of the user handling the local device) or noisy. In some embodiments, the local frame broker 160 may further be configured to encode the data it received in accordance with the communication channel characteristics (including the communication protocol used, noise level in the channel, communication bands to be used, etc.) of the link the local device established with the remote device. In some embodiments, some or all of the operations the local frame broker 160 is configured to perform may be performed by the processing unit 156.

Image frames (and other sensor data) that are likely to best capture findings derived from the data, and likely to yield the best findings sets, are thus sent, in some embodiments, to the remote device(s) housing co-processors configured to perform extended and deep learning operations on data sent from the local device(s). Transfer of the data selected by the local device may be performed by a local frame protocol transport 162, which may be similar to (in implementation and/or configuration) to the server module 120 of FIG. 1A, and may thus be configured to establish a communication link (wired or wireless) with the remote device 180 comprising the one or more analysis engines configured to process physical object data collected by sensor devices and to determine output data that may include data representative of structural deviation of the structure of the physical object under consideration from some base-line (e.g., optimal or normal conditions) structure. The local frame protocol transport 162 may implement communication functionality (transmitter/receiver functionality), and may be part of one of the other modules of the local device 152. The local frame protocol transport 162 may be implemented so that the local device and the remote device (also referred to as a remote augmenter) can operate in continuous (and bi-directional) asynchronous operation, where data transmissions from the local device 152 to the remote device 180 (and vice versa from the remote device to the local device) can be unscheduled and based on when meaningful or needed data is available for transmission. Such asynchronous mode of operation allows the device to use communication and processing resources efficiently (send communications only when data transmissions are necessary). Data transmissions from the remote device sent to the local devices (with findings data, augmented reality rendering data, etc.) may be stored, when arriving via the local frame protocol transport 162 (or through some other communication interfacing module) in a remote finding cache 164. In some embodiments, the data sent from the remote device 180 may be routed to the remote finding cache 164 via the local frame broker 162, with the local frame broker optionally performing processing on the data from the remote device 180 to cut, compress, or optimize the storage and information quality of the data from the remote device.

As further shown in FIG. 1B, the local device 152 further includes a finding reconciliation unit 166 (which may be implemented using the one or more processors of the processing unit 156) which receives stored data from the local finding cache 158 (storing any finding data that was derived locally) and the remote finding cache 164, and reconciles the data so that, for example, disagreement between any of the locally-derived and remotely-derived data sets can be handled according to some pre-determined procedure. For example, data sets with contradictory finding (one indicating a dent at a particular location; the other indicating no dent at that particular indication) may be discarded or cause the generation of a control signal or instruction to cause the local device to obtain input data with respect to the particular location or feature for which contradictory data was found. The control/instruction signal may be in the form of a graphical indicator (e.g., an augmented reality artifact) overlaid on an image of the physical object being analyzed, and indicating (based on some choice of color, shade or some other output indication) that additional sensor data needs to be obtained for the identified location or feature on the physical object. In some embodiments, other types of reconciliation operations may be performed (e.g., averaging of corresponding data sets, extrapolation or interpolation using neighboring data, etc.) in relation to the feature or finding that indicates a disagreement in the finding. Reconciled data may be converted or formatted into appropriate rendering data, using the sicky output module 172, and rendered into the output interface provided on the local device (e.g., an augmented reality artifact rendered on a graphical user interface of the local device 152). The sticky output module 172 may also cause rendering of other data (e.g., data that may not have been processed by the reconciliation module). The local device 152 may also include an input interface 174 (e.g., keypad, keyboard, touchscreen, microphone to receive audio input, etc.) that allows receipt of user input to further supplement the data being rendered locally, and/or to generate additional data that may be provided for further local processing (to derive additional findings) and/or provided to the remote device 180 to generate additional findings at the remote device.

As additionally shown in FIG. 1B, the remote device includes a remote frame protocol transport 182 which, like the local frame protocol transport 162, supports communication with the local device 152 and/or with other devices. Communication between the remote device 180 and the local device 152 may be implemented, for example, as bi-direction continuous asynchronous links for wired and wireless communication protocols. Coupled to the remote frame protocol transport 182 is a remote frame broker which, like the local frame broker 160, is configured to select portions of the incoming data (e.g., through selection of frames that most optimally match one or more selection criteria, through data down-sampling or filtering operations, etc.) in accordance with requirements of a processing unit 186 coupled to the remote frame broker 184. The processing unit 186 generally comprises one or more processing engines (e.g., one or more CPU's, GPU's, TPU's, ASIC processors, etc.) that implement an analysis engine similar to the analysis engine 130 of FIG. 1A. Thus, the processing unit may be configured to implement the various learning/classification engines (e.g., as an arrangements of modules such as the modules 132-146 shown in FIG. 1A) that perform the high level analysis on the data (as processed and provided by the remote frame broker 184) to generate findings from that data. The processing unit 186 is connected through a bi-directional configuration to a feedback continuous learning module 188 (coupled to a feedback persistence store device 190) that allows previous findings to be used in conjunction with new data and/or more recent findings to generate improved or refined findings with respect to the object being analyzed. In some embodiments, the remote device 180 may include a finding persistence store device 194 (e.g., a memory storage device) to store findings generated either by the remote processing unit 186 or by the local processing unit 156. The finding persistence store device may communicate directly with the local device 152 (e.g., via interfacing communication broker modules 192 and 176) to receive findings data that can then be used for further processing by the remote processing unit 186.

The system 150, comprising die local device 152 and the remote device 180, may be configured to perform one or more of the following functionalities. As noted, at least some of the high-level processing (to analyze the object under observation and generate findings related, for example, to structural abnormalities and determination of damage/mitigation costs) may be performed at the local device 152. However, under common circumstances, the computing capabilities of the local device would be lower than at a remote device, and therefore the remote device may be able to perform a more extensive/comprehensive analysis of the object. Thus, in such circumstances, the local device may perform an initial (and often coarser) analysis of the object and use initial local findings to take various interim actions (the findings may be used to determine how to position the device in order to obtain missing information). As more refined or comprehensive findings are received from the remote device 180, the remote findings may be used to supplement and/or correct any of the preliminary findings determined locally at the local device. As noted, the local device may use the finding reconciliation module 166 to compare or reconcile the refined findings with the initial local findings. Reconciled data can be used to generate correction to any resultant action or resultant data that has already been taken or generated. For example, rendering of graphical artifacts representative of structural damage on an output image of the object analyzed may be refined as a result of the reconciliation process, and a corrected artifact generated and overlaid on the image presented on a display device at the local device 152. In another example, corrective shading (or other types of graphical representations) may be generated through the corrective/reconciliation process to identify various parts of the object that have been analyzed, and indicate what additional parts need to be further observed to complete the analysis. The local device 152 is thus configured to incrementally build up its findings generated from both the local and remote processing suites (and subsequently stored in the cache units 158 and 164), and to increase is displayable data representative of at least some of the generated findings data.

In some implementations, displayable data (e.g., augmented reality objects or artifacts that may be overlaid on images of the object being analyzed) may be automatically adjusted to conform (be congruent with) changes of position or orientations of the observed object. The adjustments to the renderings may be based on data obtained from inertial sensors (such as a accelerometer, gyroscope, or any other type of sensor implemented on the local device) that indicates a change in the position of orientation of the device. Alternatively, corrections/adjustments to the displayable data may be based on a determination of a change between a current image of the object and a previously displayed image. Generally, change in positioning/orientation/distance between two images should be reflected by commensurate changes to the displayable artifacts that are going to be rendered on the displayed device. For example, if the image of the object becomes enlarged (e.g., because of a zooming operation, or because the camera is moved closer to the object), a commensurate enlargement for the augmented reality renderings (which may have been determined from finding produced by the local or remote processing units) needs to be determined. Thus, movement of the local device (e.g., within a range of angle deviation from the original set of frames being analyzed) may cause a dynamic adjustment to overlay findings positions from the analysis engines. The displaced local device may be configured to maintain registration with the actual current streaming image position on the screen without the need to re-run finding processes (e.g., on the learning engines or classifiers) to determine, for example, parts and damages data (including positions of such parts and damages data).

In some embodiments, either of the processing unit 156 and/or the emote processing unit 186 (or any of the other analysis engines or processing units described herein in the present disclosure) may be configured to execute contextual modeling rules to facilitate identification and detection of features. For example, the contextual rules can include positional rules regarding locations and morphological characteristics of features, including their relative locations to each other. Rules can include rules to identify features such as wheels (e.g., based on their round/circular morphological characteristics), or rules to identify front doors of vehicles (e.g., based on their relative positions to front fenders), rules identifying headlamps (e.g., based on their proximity to front bumpers), rules to identify (or at least enhance identifications) of such features as right versus left handedness, and front versus rear point of views, etc. In some embodiments, the system 150 may be configured so that local feature activation findings may be sent to the remote device, along with detailed raster data, to allow the remote device to determine specifics for deep inspection.

As noted, in some examples, the system 150 (and likewise the other systems described herein) may operate in “light” mode on local end device only when network bandwidth prohibits transmission to remote devices. Additionally, the system 150 may also be configured to throttle transmission to a minimal of selected frames based upon quick edge findings to optimize performance and capacity. In some situations, the system 150 may operate in a “collapsed” mode where all functionality is running on one device (e.g., when the amount of data is not that great that sending it to a remote device may not be warranted, when a communication channel to the remote device cannot be established, etc.) Additionally, although in FIG. 1B only one local device is illustrated, in some situations (as shown in FIG. 1A) multiple local device (also referred to as “IoT devices”), including multiple mobile or non-mobile devices, may work in concert to generate findings for aggregation. For example, each device may process data obtained through its sensors (e.g., cameras, audio sensors, inertial sensors, etc., that are coupled to or housed respectively on those individual devices). The extent/degree of processing may be adjusted based on the individual conditions and resources corresponding to each resource, with some devices executing processes (e.g., one or more of the processes described in relation to the modules 132-146 in FIG. 1A) that may not be executing on other local devices. Each device may periodically (at regular or irregular time instances) communicate raw data and/or resultant data that was locally determined to the remote device 180. The remote device may perform processing on the data provided by the individual devices, and may communicate resultant data back to the individual devices (with such return data including individual return data sent back to the respective individual devices, and/or data common to multiple ones of the local devices). The remote device 180 may be implemented as a distributed system comprising multiple remote servers/device that operate in tandem to scale generation of findings

As discussed herein, the findings data, generated either by the local device 152 and/or the remote device 180, may include representations of parts outlines, damage peaking highlights, mask overlays on parts or damages, 3D synthetic vehicle models (which can be superimposed on actual vehicle images), heat maps over parts or damages, bullet points with text callouts, color coding of pass/fail/warning, etc. In some examples, one or more of the processes implemented at the local or remote device may populate butterfly diagrams to illustrate where key points are for consideration. In some embodiments, processes implemented at the local devices or remote devices may be configured to identify negative cases (in a defensive mode) where items or images are rejected from consideration. Such items may include faces, fingers, blurry, glare, reflection artifacts, non-subject-of-interest objects, etc. Negative cases are similarly Augmented Reality render able as a class type. For example, in some situations, this may simply be a classification of findings that are marked as “passed” or “acceptable,” and findings that are flagged as “anomalous,” “superfluous” or “erroneous” as a set of defenses that can be displayed as a group or class of “defensive findings.” Various implementations can switch between class representations on the screen.

In some embodiments, findings may be aggregated in a “sticky” implementation whereby each finding is aggregated and accepted into an un-edited capture of AI augmentations. For example, damage data representative of damage to an object (such as a vehicle) may he determined, and resultant output (e.g., location and data, such as graphical data, representative of the damage) may be produced by a processing unit (at the local device or remote device). The location data determined may be a relative location that is derived, for example, relative to a current image frame displayed on the user output interface of the local device. The data can be provided to the local device (if this output data was generated at the remote device) and after being subjected to a reconciliation process (e.g., to make adjustments to the locations or values of the output data that depend, for example, on any changes to the orientation and position of the current image frame) the output data (if such output data is image data) may be overlaid on the current image frame.

in some embodiments, the findings data may be used to determine the completeness of data available for the object being analyzed, and may thus he used to determine what information, if any, is missing. Based on what information is missing (or lacking, if certain features are associated with a low accuracy confidence level), guidance data may be generated (e.g., by the local processing unit, the remote processing unit, or some other local or remote unit) that directs a device (if the device can be controlled or actuated to change its position and/or orientation), or directs a user, to manipulate the device to a position and/or orientation that allows any of the missing or low-confidence information to he obtained. For example, as noted, the analysis engines implemented by the various devices determine/detect parts for an identified object. Such analysis can, upon determining that a threshold amount of information has been obtained for one of the parts of the objects, be used to generate graphical data (e.g., an artifact or data representative of a shade or color) that is to be added to particular areas of an image of an image presented on the output display of a local device. The rendering of such graphical indication data will thus indicate to the user which parts of the object have been sufficiently identified or observed, and which parts either have not been identified or require additional sensor data collection therefor. Accordingly, in such embodiments, real-time feedback and coaching/guidance can be provided to the user to prompt the user to adjust position, distance, angle, and/or other positioning attributes, to improve capability to identify and capture additional sensor data (e.g., video, audio, etc.) for the object being analyzed.

In some embodiments, the local device 152 may be configured to use geo-positioning data/accelerometer data (and/or other inertial sensors' data), and image processing data to map close-up findings and distant findings with respect to near-spatial movement and kinetics measures to generate aggregation elements and augmented reality overlay. In some embodiments, voice command and commentary on activations (e.g., audio data provided by the user and captured by an audio sensor on the local device) may be converted to text and used to enrich the input to the processing engines to be processed, and then accepted or rejected into the augmented reality capture. In some examples, text output, generated based on voice data, can be rendered on screen and in tabular reports.

In some implementations, key streaming images may be snapped into memory buffers and used in a recall process for geo-positioning virtual reality overlay of findings over time series and time sequence. The system 150 (or any of the other systems and implementations described herein) may build collection of pre-established views/viewpoints to snap-capture some of the key positions of the physical object being considered, including front corner of the object (e.g., front-corner of a car), side, rear, etc. Once the fixed collection of views is completed, the record copy is done. For example, an important aspect is point-in-time discovery identification. Insurers often have specific pictures they want to complete the audit or capture. This may be considered a “reference set” and each image from each viewpoint is expected to be captured. The same reference set may be required the next time the same vehicle is evaluated. A mobile camera will thus need to go back to a snapped view and then overlay findings, masks, highlights, etc., generated from the remote system. A user may go forward and backward across the reference set to see such enriched shots, and then make final selections on the ones to be used in the final capture as sent to record.

Another feature of the system 150 includes implementing moving-closer and moving-farther-away positioning, and correlating close up damage detection with farther-away-parts detection to increase overarching collection of attribute findings. In some implementations, multiple frame image positions may be generated so allow reverting to, or pointing back to, the best frame under consideration for selection by the user, or for selection through an automated selection process. As noted, another feature that may be implemented includes the ability to swap-out preciously rendered sticky features with newly produced representations that were generated from better quality data (e.g., data, associated with a higher confidence score or with a better noise metric (such as SNR) scores). In some embodiments, the local device 152 may be configured to allow the handling user to direct the IoT to include new findings or exclude prior findings. Inclusion or exclusion can be multi-modal, i.e., based on touch data, voice-date, detection of eye movement or body gesture, etc.

Aggregated data can become a working data set for final processing. Thus, as the system is incrementally capturing and growing findings on both the local edge (e.g., the locally data acquisition devices) and the remote server, at some point the collection and aggregation comes to a conclusion. At that point all of the collected structured data is frozen as the working data set and can then be processed through the final evaluation process. Final processing may include performing triage on the findings data (e.g., based on user selection, or based on an automated selection process of determined findings data) to accept certain features (corresponding to one or more findings data sets), reject some features, suppress various features , re-label some of the features, and/or add missing features. In some embodiments, data may be captured in a final ontology taxonomy from the local device. In some examples, the user may select certain portions of acquired data for record capture. The implementations may include continuous video feed, with data capture being tamper-resistant and/or and realized as a method of encapsulation and risk mitigation.

As noted, the systems described herein may be configured to implement synthetic object generation and comingling of real subject data and synthetic subject data to generate enhanced data models and augmented reality detections and overlays. For example, the various learning and classification engines operate on acquired sensor data (e.g., image data) to detect the type and locations of various features of the object under examination. The output data of those learning and classification engines may include, or may used to generate, artifacts data representative of synthetic objects (graphical objects) that can be overlaid on acquired images (to identify areas and other features in the underlying image of the object being analyzed). The graphical data to be rendered may include data representative of 3D models of the object(s) being analyzed, and may be computer rendering the artifacts to be overlaid, a hybrid combination of actual image data (e.g., based on a previous raster capture of the object) and computer-generated data, or graphical data generated substantially entirely from actual image-captured data. Graphical data to be rendered may be based on graphical data representative of multiple viewpoints of rendering of the object analyzed (e.g., according to an x,y,z axis rotational viewpoints). Acquired or generated output data may include positional information corresponding to the data (e.g., embedded in metadata for the data).

The systems and implementation described herein are configured to collect/generate vast quantities of synthetics renderings that may include: a) each component/feature part of the object (e.g., a car) rendered in isolation and being capable to be manipulated for different rotational angles and orientations in order to generate image masks, b) combination of component parts (features) of the object being analyzed, rendered as composite (optionally with each part assigned a different grayscale value), c) combinations (and is some cases all) component parts of the object under consideration may be rendered in composite with all parts assigned the same grayscale value, and/or d) real image captures of the object tinder consideration, e) damage types that are representative of actual damages such as scratch, dent, break, crack. In some embodiments, orientation and object parts identification processes may be developed based on the synthetic output data generated using the various learning and classification engines (and/or other processing unit implementations.

In some examples, equivalent algorithm networks are developed from real subject data (for the object(s) being analyzed). Thus, annotated data that is used for training may be obtained from actual damaged/not-damaged vehicle photos (the “real subject data”). Annotation tagging identification process is performed on the real photos, and that data may be used for algorithm development and testing.

Real objects generally include poly-lines that may be manually or automatically drawn around each of the component parts. Poly line and real image overlay are used to extract the component part under consideration, and positional viewpoint processes generate x,y,z axis rotation values. In some embodiments, synthetic training data can be combined with real training data for enhanced hybrid approach to creating algorithms.

A few example scenarios are provided to illustrate the use of synthetic subject data as described herein. In a first example scenario, generally available processes, such as mask-rcnn (that already utilizes multiple processes/weights that are chained to produce results) are accessed. Synthetic images are run through mask-rcnn to generate algorithms weights (including training output data for use with AI algorithms). Starting points within mask-rcnn are substituted/replaced to implement a transfer learning approach with recently created synthetics results. Real images are then run through modified mask-rcnn to generate next level algorithm training.

In another example scenario, generally available algorithms/processes, such as mask-rcnn (that already utilizes multiple algorithms/weights that are chained to produce results) are utilized. Synthetic images are run through mask-rcnn to generate algorithms weights, and real images are run mask-rcnn to generate algorithms weights. An ensemble network uses synthetic subject data and real subject data to improve algorithm accuracy performance. In this scenario, multi-task learning is implemented by, for example, changing a loss function to weight real subject data or synthetic subject data in order to emphasize one of the algorithm processes as may be appropriate for different types of detections. Fundamental to the process is the quantity of synthetic subject data that is combined with the quantity of real subject data for each of the detections that are being trained for influencing the accuracy of the training.

Additional features that may be implemented or supported using the systems described herein (e.g., in relation to FIGS. 1A and B) include: a) utilizing/generating a map architecture to traverse a tree of activations (such as dropout, layer, etc.), b) using low level filters with additive high level additions to resolve working algorithms, c) trimming historic images and datasets, and introducing new data from continuous learning feedback loop, d) tagging annotations polys, and/or e) implementing a neural network that is explainable by using decision trees (instead of linear functions) and connecting the trees using non-linear functions.

FIG. 1C is a block system interaction diagram 190 showing some of the various features and processes implemented at the various parts of the systems 100 or 150 illustrated in FIGS. 1A and 1B. The end user device 192 may be similar to the local device 152 and/or to any of the devices 110a-n. Thus, the device 192 includes a camera 194a to capture images of an object (such as a vehicle) which can be processed locally (using the GPU 194b) and/or using other processing devices provided locally at the device 192. As noted, in some embodiments, high-level processing, which may be implemented using learning engines/classifiers, to identify the object being analyzed, detect, parts thereof, determine structural abnormalities (corresponding to damages), determine mitigation actions (damage fixes and costs), generate data (including graphical data, produced as synthetic subject data or as graphical data based on previously captured images), etc., may be performed partly at the local device 192, or at a remote processing system (collectively marked as system 196) which is accessible by one or more users (including the end user, insurance representative and/or other agents) via application routers (198a and b) and web-services server 198c connected to a network (wired and/or wireless). As noted, the local device and remote systems implement a feedback loop configuration in which high-level analytic results (e.g., data identifying parts/components, and graphical data to be rendered at a display device of the local device 192) are provided to the local device. The data sent back to the local device can be used to guide the device (either automatically or manually through manipulation by the user) to collect missing or incomplete information. For example, the remote system may send graphical data representative of parts components that have been identified for the object being analyzed, and the graphical data may then be rendered on the local display device (using a dynamic screen render module 194c). Such renderings can be indicative of the degree of information completeness for various parts of the identified object. As discussed above, the dynamic screen render module 194c may be configured to process and transform the rendering based on locally available information (e.g., positional changes of the device) so that, for example, the rendered graphics are properly overlaid on images of the object captured by the camera 194a.

In addition to the various units discussed in relation to the FIGS. 1A and 1B, and the dynamic screen render module 194c of FIG. 1C, the local device 192 further includes a reports summary stats module 194d that presents data (e.g., damage report, cost report, etc.) derived from the data captured by the local device's sensors, an optional authentication login admin module 194e that control access to the device and/or to certain units of the local device 192, a help learn interactive AI module 194f to provide help information (as may be needed by a user), and/or a claim record image module 194g to present information in relation to any claim (insurance claim) created with respect to the object under consideration.

Turning next to FIG. 2, a block diagram of an example analysis system 200 to process physical object data and determine structural anomalies/deviation therefor is shown. The example implementation of the system 200 may be similar, at least in part, to the implementation of the analysis engine 130 depicted in FIG. 1A. The analysis system 200 includes an input stage 202 to receive data (e.g., physical object data). The input stage may include a communication interface, configured for wired and/or wireless communication with data acquisition devices (such as the cameras 1110a-n shown in FIG. 1A). The input stage 202 may, for example, perform such operations as decoding (e.g., decrypting and/or uncompressing received data), authenticating the data (e.g., using key-based signing schemes), and other input receiving functions (signal filtering, data pre-processing, etc.) The input data received and processed via the input stage 202 is provided to a type check module 204 which is configured to perform source material input type validation (e.g., determine the type of data received; for example, whether the data includes image data from image-capture devices, voice data, user-provided text data, or any other data type). The determination of the data type (and/or its validation) may be used to direct the data to the appropriate processing engines and/or to activate appropriate processing modules and/or reject certain type of images that are not of the proper quality or do not contain objects of interest for further processing. For example, different learning engines may be activated to process the data depending on the type of data the is determined to be present at the type check module 204. In some embodiments, the input stage 202 and/or the type check module 204 (or some other module) may be configured to control, automatically and/or based on input from a user, activation/actuation of one or more of the data acquisition devices (edge devices) to collect additional data. For example the input stage 202 may be configured to cause one or more of the cameras 110a-n depicted in FIG. 1A to capture target image data for transmission to the processing engine (for further processing in real-time or through batch processing). The input stage nay be configured for automatic or manual data acquisition triggers based on an analysis of the data content currently available (e.g., what details are seen in current captured views of the cameras), and a determination what additional content (additional views) or enriched content (e.g., enriched captured views) would be needed. Such analyses and determinations facilitate the process of obtaining the correct data (e.g., capturing the right photos) needed to assess costs for repairing structural damage of the object (e.g., assess cost for parts and damage estimation, as will more particularly be described below).

Having determined, by the type check module 204, the general data type of the data to be processed and analyzed, the received data is provided to central orchestrator 210, which is configured to activate and control the appropriate implementations corresponding to various processes including an object identification process 220 a parts process 222, a damage process 224, a granular damage detection process 226, and a damage severity process 228. The orchestrator 210 may also be configured to control the flow of output data resulting from processing applied to the data to decision modules controlled by a decision aggregator 230. Thus, in some embodiments, depending on the type of data received, different implementations of the processing units 220-228 will be activated. For example, if the data received includes text, voice or other types of non-image data, a first type of processing implementations may be activated to perform the processes 220-228. If, on the other hand, the input data is determined to correspond to image data, a different set of implementations for the processes 220-228, configured to operate on image data, may be activated. For the sake of illustration, examples described herein will focus on processing applied to image data; however, similar processing may be applied to other types of data, but using different implementations of the various processes and modules described in relation to the system 200. In embodiments in which image data is processed through the various modules of the system 200, the orchestrator 210 may further be configured to preprocess image data into a 3-dimensional tensor (BGR) that are fed to the implementations for the various processes 220-228.

In some embodiments, the orchestrator 210 is configured to cause neural networks (including the neural networks' definitions and weights) to be loaded (e.g., into dynamic memory). Neural networks are in general composed of multiple layers of linear transformations (multiplications by a “weight” matrix), each followed by a nonlinear function. The linear transformations are learned during training by making small changes to the weight matrices that progressively make the transformations more helpful to the final classification task. A multilayer network is adapted to analyze data (such as images with specific network architecture for every age modality), taking into account the resolution of the data images (e.g., in a preprocessing step comprising re-sizing and/or transforming the data). The layered network may include convolutional processes which are followed by pooling processes along with intermediate connections between the layers to enhance the sharing of information between the layers. A weight matrix of the neural network may be initialized in an averaging way to avoid vanishing gradients during back propagation, and enhance the information processing of the images. Several examples of learning engine approaches/architectures that may be used include generating an auto-encoder and using the dense layer of the network to correlate with probability for a future event through a support vector machine, or constructing a regression or classification neural network model that predicts a specific output from an image (based on training reflective of correlation between similar images and the output that is to predicted), and/or constructing an outcome prediction that a specialist (e.g., an appraiser or an actuarial specialist) would make. Upon training of a neural network, new data sets (e.g., images) are generally processed at scale with the neural network and output data is generated. A report providing germane data regarding repair or replacement estimates (e.g., for a car or some other object), and/or other information, is generated. The output of the processing (including intermediate outputs) can be stored in a database for future reference and mapping.

Examples of neural networks include convolutional neural network (CNN), recurrent neural networks (RNN), etc. In a CNN, the learned multilayer processing of visual input is thought to be analogous to the way organic visual systems process information, with early stages of the networks responding to basic visual elements while higher levels of the networks responding to more complicated or abstract visual concepts such as object category. Convolutional layers allow a network to efficiently learn features that are invariant to an exact location in an image by applying the same learned transformation to subsections of an entire image. In some embodiments, the various processes activated or otherwise controlled by the orchestrator 210 (e.g., the neural networks, such as CNN's or other types of neural networks, as well as non-neural networks processing modules) may be realized using keras (an open-source neural network library) building blocks and/or numpy (programming library useful for realizing modules to process arrays) building blocks. In embodiments in which keras building blocks are used, the resultant processing modules may be realized based on keras layers for defining and building neural networks, keras models sequential (type of a piece of a model), keras SGD (stochastic gradient descent) optimizer to define/train weights of the neural network, a keras model for overarching wrapper for the model definitions, and keras backend to expose deep mathematical functions that are not already wrapped.

Output of the orchestrator 210, produced through application of one or more of the processes 220-228 to the data received by the orchestrator 210, is provided to the decision aggregator 230. As will discussed in greater detail below, in some embodiments, a process request (e.g., to assess structural state, including structural deviation or damage, of an object) provided as raw data of multiple images that are individually processed via the processes 220-228 of the orchestrator 210, with the respective results produced being processed by the decision aggregator 230 to produce aggregation output. The aggregation output from the decision aggregator is then used to, for example, populate the elements of a cost mapper 240, by having the aggregation output derived from the decision aggregator's processes (e.g., processes 232, 234, 236, and 238, discussed in greater detail below) applied (e.g., hashed) into deep data structures implemented by the cost mapper 240. For every image (or other type of data) processed through this procedure, the decision aggregator 230 may provide unique scores, parts, severity and damage detection for each image so that the deep data structures contain only one instance of each type of abnormality at the end of the processing performed by the system 200. For each observation of abnormality of the processing performed by the system 200, an observability code is derived which depends on a probability (confidence score) associated with the processing performed, and the accuracy of the localization of the structural state (i.e., whether the structural damage was accurately localized). Based on the output of the observability code, a “safety net” exit return takes place if sub function thresholds are exceeded, in which case a human technician may intervene to provide a visual assessment of the structural state of the physical object.

The processes 220-228 will next be discussed in greater detail. Particularly, the process 220 is configured to analyze the data (e.g., image data) provided to the orchestrator 210 to identify whether an object is present in the data, or whether the data provided is an image devoid of objects requiring further processing. In the event that an image includes an object requiring further processing, a determination of an object type or category is also performed. If the data is determined to not include object data, further processing for the current data (e.g., by the other processes of the orchestrator 210 and other modules of the system 200) may terminate, and the next set of data (if available) is processed. In some embodiments, image data is provided to the process 220 in the form of a BGR (blue-green-red) tensor, with dimensions (height, width, channels) of entries comprising unsigned 8-bit integers elements. In embodiments in which the process 220 is implemented using a neural network model, the neural network may have been trained using appropriate training data, resulting in vectorized data array of neural-network weights representative of the model. An output of such neural network processing may be data representative of whether the input data includes a target object and/or data representative of the type of physical object appearing in the input data. Example of types of objects that may be identified by the process 220 include: i) exterior of the image or other parts related to vehicles, ii) exterior portion of a vehicle detected, iii) interior portion of a vehicle detected, iv) VIN number of a vehicle detected. The output data may be in a form corresponding to annotation or codes such as ‘exterior’, ‘garage’, ‘interior’, ‘vin’, ‘paper’, ‘other’, etc. In some situations, the output of the process 220 may be provided as input to other processes of the orchestrator 210, such as the find damage process 224.

The parts process 222 is configured to identify or detect features/details (i.e., parts) of the physical object and produce output indicative of those identified parts. In embodiments in which the data provided is image data, the image data is resized and transformed, and passed to a region proposal network. The region proposals are passed to a neural network, such as a fast CNN classifier network, to determine which objects are present. The integration of the region proposal and classifier networks is done by leveraging the faster R-CNN architecture with, for example, Resnet50 base architecture for the convolutional neural network. The data returned by the process 222 takes the form of class name, probability of class (as learned by the neural networks), and bounding box coordinates. More particularly, the image data may be provided to the parts process 222 in the form of a BGR (blue-green-red) tensor, with dimensions (height, width, channels), and elements comprising unsigned 8-bit integers. The image can then be re-sized by comparing the smaller image side (height or width) to a pre-assigned size (represented in pixels). The image is then re-sized such that the smaller of the image sides matches the pre-assigned size, while re-sizing the other sides to maintain the aspect ratio of the original image. Any necessary interpolation may be performed using an bicubic interpolation procedure. In some embodiments, the re-sized image is then transformed by first converting the data elements to single-precision floating point, and then mean-normalizing by a predetermined training sample mean. The placement of channels in tensor dimensions should matches that of the deep learning backend (e.g., Tensorflow, Theano).

Prior training data model array weights file comprising weights (trained on bounding boxes coordinates and classes) fill the faster R-CNN architecture. The same weights may be used for localization and classification of the parts on the image. The output of the classifier includes a dictionary array containing a numerical array of pixel coordinates for localized regions of interest on the image that represent a segmenting of the physical object under observation into parts of interest.

The process 222 may thus return an array of classes for each of the identified regions of interest, including returned coordinates defining which areas in the image are of interest for further processing (e.g., by, for example, the granular damage detection process 226). The entries of the array of classes may also include codes representative of the object type identified in the respective region-of-interest. In embodiments involving the processing of vehicle-type objects, such codes/annotations may include semantics such as ‘wheel’, ‘rear light’, ‘fender panel’, ‘window glass’, ‘luggage lid’, ‘rear window’, ‘hood panel’, ‘front light’, ‘windshield glass’, ‘license plate’, ‘quarter panel’, ‘rear bumper’, ‘mirror’, ‘front door’, ‘rear door’, ‘front bumper’, ‘fog light’, ‘emblem’, ‘lower bumper grill’, etc. These annotations may also be used for training purposes of the classifier. The parts process 222 may also return, in some embodiments, a numerical score indicating the certainty (confidence) or the accuracy of the output.

In some embodiments, the re-sized and transformed image data may be provided to a separate classifier implementation (different from the one used to identify specific object types in detected regions-of-interest) which looks for regions of interest in the given image and classifies these regions of interest as either ‘background’ or ‘object’. For those regions classified as ‘object’, a classifier network, such as the one described above, classifies the detected ‘object’ regions as a specific kind of ‘object’ (e.g., an exterior automotive part). Alternatively, in some embodiment, the image segmentation operations may be performed by a single classifier that determines, for each region, whether the region is an ‘object’ region (and if so also determines for such ‘object’ regions the object type appearing in the detected region), or a ‘background’ region (this can be done by a pixel detail level classifier).

Thus, the parts process 222 is configured to receive image data, re-size, and transform the image data to be compatible with the data representations required by the one or more classifier implementations of the process 222. The re-sized and transformed data is passed to the region proposal network to detect ‘object’ regions and ‘background’ regions. Region proposals (particularly, candidate ‘object’ regions) are passed to a classifier network to determine which objects are present. The information returned by the process takes the form of class name, probability of class (as learned by the neural networks), and bounding box coordinates. In some embodiments, similar bounding boxes may be grouped together and then pruned using non-maximum suppression, based on probability.

With continued reference to FIG. 2, in some embodiments, the damage process 224 is used to analyze an image to ascertain the presence of a deformation or abnormality in the object of interest. The input analyzed by the process 224 (which, like other process implementations of the orchestrator 210 may be realized based on a classifier, such as a neural network which may be the same or different from neural network implementations used for executing the other orchestrator's processes) may include image data represented in the form of a BGR (blue-green-red) tensor, with dimensions (height, width, channels), and elements represented as unsigned 8-bit integers. The classifier implementation used for the damage process 224 may be loaded with a data model array weight file (derived based on previously-performed training procedure), provided as a vectorized data array of weights, corresponding to the particular object detected in the image (as may have been determined through the process 220). In some embodiments, the weights fill a VGG16 architecture with the top layer removed, and seven (7) new dense layers added with 4096, 2048, 1024, 512, 256, 128, 64, and 2 neurons respectively. In some other embodiments a localization neural network 226 is used in as an ensemble with the classifier to enhance the damage classification capability of the module.

The output produced by the damage process 224 may be values (e.g., as a binary decision) indicating whether the input includes possible damage (or deviation from some optimal structural state or a structural baseline). In some situations, the output may he included within a numerical array, with each entry providing a damage/no damage indication for a respective data set (e.g., one of a plurality of images being processed by the system 200). The output of the process 224 thus provides an indication of whether damage is detected on the object or is not detected on the object, and may he provided as input to another process (e.g., the granular damage process 226). Thus, an indication of no damage may be used to terminate more intricate (and computationally costly) processing of data if the binary decision reached by the process 224, for a particular data set, indicates that no structural abnormality has been globally detected for the particular data set. In addition to a damage no-damage indication produced by the process 224, the output of the process 224 may also include a value (provided as a real number) indicating the probability of a correct assessment in relation to the presence of damage in the particular data set. If the probability exceeds a certain predetermined threshold (e.g., probability of ≥90%), a decision may be made to proceed or terminate downstream processing for the particular data set (e.g., not execute granular damage processing if the probability of no-damage exceeds 90%).

Having derived an array with regions of interest that are each associated with probable respective object classes (object parts, such as auto parts), and (optionally, in some embodiments) having determined that damage is likely present in the particular data set (image) currently being processed by the orchestrator 210, the granular damage process 226 may be invoked/activated. Here too, implementation of the granular damage process may be achieved sing neural network architecture to determine localization and granular characterization of damages on the object being assessed. The granular damage process may receive a vectorized data arrays of video, image, metadata (e.g., identification of object parts, as may have been determined by one or more of the upstream processes of the orchestrator 210, as well as metadata provided with the original data such as descriptive terms, identification of subject matter, date and time, etc.) In situations where the data received by the process 226 comprises image data, the image may be re-sized and/or transformed (i.e., normalized) in a manner similar to that described in relation to the re-sizing process performed during the parts process 222. Thus, the re-sizing may include re-scaling the smallest dimension (width, height) of the image (or a portion thereof) to a pre-set value, and re-sizing the other sides to maintain a predetermined aspect ratio and pixels size.

In circumstances where the granular damage process 226 is implemented as a neural network, a vectorized data arrays of weights, trained on bounding boxes coordinates that describe a class of object referring to a specific part of the object is loaded onto the neural network. As discussed herein, the neural network implementation (be it a hardware, software, or a hardware/software implementation) may be the same or different from other neural network implementations realized by the various processes and modules of the orchestrator 210. In some embodiments, the same weights may be used for localization and classification of the objects on the image describing the separate damages detected on the overall image.

Output produced by the granular damage process 226 may include a dictionary array containing a numerical array of pixel coordinates for localizing different types of detected abnormalities on the image. The output may also include an array of the classes of each of regions-of-interest where coordinates are returned. The output produced by the process 226 is provided to a memory array whose data is representative of an assessment of which abnormalities have been detected on which part of the object (e.g., through comparison of the coordinates determined by the parts process 222 with the output derived by the granular damage process 226). The output produced may also include a numerical score indicating the certainty or accuracy of the output. In some embodiments, the training of the process 226 may result in the development of tag attribute annotations (semantics) configured to recognize the various types of damage present in the images with separate classes and bounding boxes enclosing the damage. Annotations or codes used for granular damage detection may include, for example, one or more of ‘break’, ‘bumper separation’, ‘chip’, ‘crack’, ‘dent’, ‘glass damage’, ‘gouge’, ‘light damage’, ‘missing piece’, ‘prior damage’, ‘scratch’, ‘scuff’, and/or ‘tire damage’.

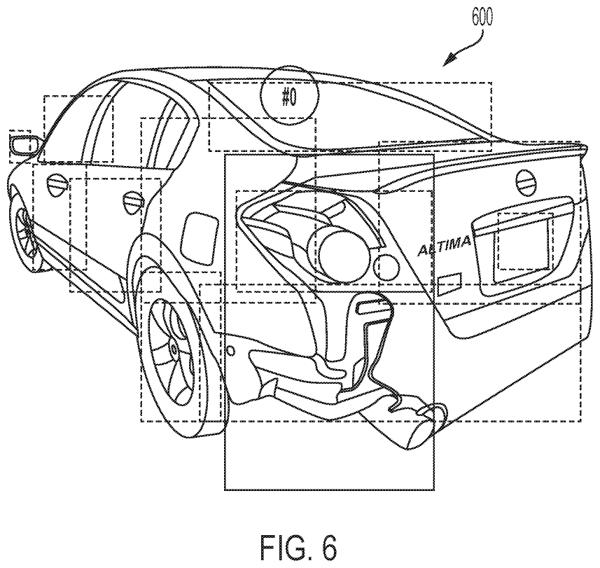

Thus, the process 226 is configured to receive data, such as image data represented in the form of a BGR (blue-green-red) tensor, with dimensions (height, width, channels), and elements represented as unsigned 8-bit integers values. The image may be re-sized and/or transformed (or otherwise normalize) so that the transformed data is compatible with the configuration of the neural network (or other classifiers) used. An example of a transformation procedure that may be used is as follows: 1) mean-normalization by subtracting a predetermined training sample mean from each of the three (3) color channels, 2) resizing the image data so that the smaller side of the image is of a size of at least a preset minimum pixel length (e.g., 600 pixels), with the larger side being no larger than a preset maximum pixel length (e.g., 1024 pixels), and 3) ensuring that the placement of channels in tensor dimensions matches that of the deep learning backend (e.g. Tensorflow, Theano). The transformed image is passed to a model, which has been previously trained to detect specific types of objects. The output of this model is the class name for various objects detected in the image, with the probability of those objects actually being in the image (as learned by the neural network) and bounding boxes coordinates (also learned by the neural network). All the bounding boxes associated with a specific class are compared, and are pruned if the level of overlap between two boxes is above a predefined threshold. In the case of overlapping boxes, the one with the higher probability may be kept. The coordinates for all bounding boxes are then resealed to match the scales returned by the other processes of the system 200. An example of a processed image 600 comprising bounding boxes is provided in FIG. 6.

In some embodiments, the granular damage process 226 may also be used to assess, via a neural network (which may be constituted as a separate implementation from the other neural networks used in the processing described in relation to the modules of the system 200) the severity of detected damage. Thus, in such implementation, the process 226 may also be used to triage the level of damage for the physical object being analyzed. As noted, the input to the process 226 (which may also be used to derive the damage severity) may include vectorized data arrays of video, image, and metadata. Where the physical object data includes image data, an input image may be initially re-sized (to be compatible with the implementation of a neural network used to assess the severity of damage) by, for example, resealing the image's smaller dimension (the x or y sides associated with the image) to a specific aspect ratio and pixels size. The neural network configured to assess the damage may load a vectorized data arrays of weights trained on bounding boxes coordinates that describe a class of object referring to a specific part of the object. In some embodiments, the same weights used for localization and classification of features in the image may be used to identify/detect damages (and/or the severity thereof). The output of the process to assess the severity of the damage may include a numerical array of pixel coordinates for localizing different types of detected abnormalities on the image. The output may also include an array of the classes of each of the regions-of-interest for which coordinates are returned. This output can be used to determine what abnormalities have been detected, and where they have been detected in an image, by comparing the coordinates determined through the parts process 222 and the granular damage process 226. In addition, the output of the process 226 may include indications, in the form of codes/annotations such as ‘minor’, ‘moderate’, ‘severe’, and/or ‘none’, to represent the severity associated with detected damage present in an image. As noted, in some embodiments, the use of multiple cameras (such as the cameras 110a-n depicted in FIG. 1A) to obtain image data for an object from different directions, allows derivation of stereoscopic information, based on which distance and depth perception for the object can be computed, which in turn facilitates detection of damage to the structure of the object and determination of damage severity.

As further shown in FIG. 2, the system 200 also include an observability process 228 that provides an indication of the overall outcome resulting from application of the processes 220-226 on a particular image (e.g., an indication of whether the processing of the modules/processes of the orchestrator 210 resulted in a successful detection of structural abnormalities associated with the object being analyzed). The observability process 228 is configured to factor results from the outputs generated by the multiple processes 220-226 to generate an observability code. The observability code captures the cognitive ability of the processes (in this case, the processes of the orchestrator 210). Thus, the observability process 228 receives the output from the parts process 222, the damage process 224, and the granular damage process 226, and outputs a text string providing a description of the outcome of running the process on a specific image, which can be used to help identify the successes and failures of various processes (this, in turn, may be used to perform adaptive adjustments of the operations of the processes, e.g., through adjustment of weights of one or more neural network implementations used for the processes). The output may also include a numerical score indicating which scenario, from a finite number of scenarios, the outputs from the processes 220-226 correspond to. This score may be used to determine whether the processing of the image by the various processes was successful or not. Example codes may include the following: a) ‘600 summary’ indicating that exterior damage was detected and damage location and damage type was identified, b) ‘610 summary’ indicating that exterior damage was detected but parts were not identified, c) ‘611 summary’ indicating that exterior damage was detected but damage location was not identified, d) ‘612 summary’ indicating exterior damage was detected and parts and location were identified but with low parts confidence, e) ‘613 summary’ indicating exterior damage was detected and parts and location were identified but with low damage overlap confidence, f) ‘614 summary’ indicating exterior damage was detected and parts and location were identified. but with no damage overlap detected, g) ‘620 summary’ indicating damage was detected but was complex and requires additional processing, h) ‘630 summary’ indicating that the processing was unable to confidently detect exterior damage, and i) ‘640 summary’ indicating that the processing was unable to detect a vehicle exterior. Additional or other codes to indicate other situational summaries may be used.

As noted the outputs produced from the dense or other layers (e.g., from processes 220-228 depicted in FIG. 2) are combined at the process 212 (e.g., concatenated 5 rows×256 columns) to generate, at the process 214, input on a cascade of matrix operations (e.g. convolutions and pooling) that start with the input of 212 and transform the input matrix to he decision matrix dimensions while employing at the end of the transformations an optimization process 216 using stochastic gradient descent. The output of the optimization process 216 may include, in some implementation, ground truth output for use by a decision logic matrix. The decision matrix is a three-dimensional matrix with dimension of A, where A equals the absolute number of parts, B, where B is the absolute number of the type of damages for each part, and C, where C equals a decision for repair/replace/do nothing for each part with potential damage or lack of it. Thus, in such embodiments, the ground truth, corresponding to the decision logic matrix 237 created by the interpretability block and cost mapper (232-236 and 240), can be generated by an optimization process 216 which is trained using as input the 212 matrix.

Having processed the physical object data to detect such information as features and damage that can be discerned based on the data, the output from the processes 220-228 of the orchestrator 210 is provided to the decision aggregator 230. The decision aggregator 230 is configured to analyze the multiple outputs (data elements) generated from multiple processes of the orchestrators applied to multiple data sets (e.g., multiple images) to build cognitive responses. The decision aggregator thus includes several processes (which can be run independently, or in concert with each other), including a parts aggregation process 232 to collect/aggregate the unique parts identified (coded) or otherwise detected from the multiple data sets, a damages aggregation process 234 configured to collect damage data elements detected from multiple data sets (e.g., based on the outputs of the find damage process 224 and/or the granular damage process 226), an overlap checker process 236 that is configured to provide descriptive damage localization on separate parts of the object, and a repair or replace process 238 which determines corrective action for damage identified and coded.

More particularly, the parts aggregation process 232 is configured to synthesize elements detected by the parts process 220. Such processing is especially useful in the case of an input comprising multiple images, where the same object of interest may be recognized in multiple images and a synthesis of these recognitions is necessary in order to deliver pertinent results. The damage aggregation process 234 is configured to compare elements detected by the granular damage process across different images to remove redundant information (e.g., redundant damage tags that identify the same damage for the physical object) so as to simplify the output and decrease processing time of future process execution. Further pruning of damages occurs through removal of damages only associated with specific parts (e.g., remove information pertaining to the head and tail lights when the information being compiled is related to a car's windows). The overlap checker process 236 is configured to receive the output from the parts aggregation process 232 and the damage aggregation process 234 and return various pairing of damage to specific parts of the physical object (the car). First, the outputs of the two processes are resealed to the original image size, so they can be compared to each other and to the ground truth states (which are used to properly train the processes). The overlap area of the resealed hounding boxes from the parts aggregation process 232 and the damage aggregation process are compared to the area of the damage hounding boxes, and if the ratio of the two is above a threshold (which may be an adaptive ratio), the pairing of the part and damage are added to a dictionary, along with the confidence scores and coordinates of overlapping box.

The repair or replace decision process matrix 238 combines elements from, for example, the parts aggregation process 232, the damage aggregation process 234, and the overlap checker process 236 to generate custom metrics for the amount of damage sustained to each part (the processes 232, 234, and 236 together implement an interpretability block). These metrics are used to determine which parts should be repaired and which should be replaced (if the cost of repairing surpasses the price of a new part, utilizing data from blocks 242-246) along with the various costs relating to installing the part onto the vehicle. In some embodiments, the decision logic may be realized using the module 237, with the module 237 being adaptable/configurable using output of the stochastic gradient descent optimization as a cost function 216 but with different optimization functions (e.g., implemented as a decision tree, a neural net, or some other implementation). Repair or replace decisions are made part-by-part as there are many part specific factors to take into consideration, such as the price of different parts (which may vary dramatically and have different costs associated with their installation). The repair or replace process 238 may thus be configured as a process that obtains the output of the preceding (upstream) processes (such as the processes 232-236, but possibly outputs from other processes such as the processes 220-228) and apply rules driven decision logic on that collected data to decide the necessary course of action for restoring the structural abnormalities detected for the physical object being analyzed. In some embodiments, the rules for the decision logic may include: a) the extent of damage based on comparing the surface area of the damage versus the surface of the part affected, b) the localization of the damage on certain areas where the damage is considered critical leading to an escalation on the decision on how to restore the affected object (i.e. replacing instead of repairing), and/or c) the type of the damage which affects the labor hours needed to restore the damage in comparison with the overall cost of the affected part (for example, in certain cases it is more cost effective to replace a part of the physical object rather than restore it manually with labor). In some embodiments, the decision logic may have been prepared or configured using a learning engine as described above.

With continued reference to FIG. 2, the output of the decision aggregator 230 (and the orchestrator 210) is provided to a cost mapper 240 which is configured, based on rules-driven decision logic (which may have been prepared and/or configured using a learning engine), to determine the course of action for remediating the abnormality for the object (e.g., analyze the refined and reduced data elements based on the decision aggregator output). Similarly to the rule-driven logic implemented for the repair or replace process 238, in some embodiments the rules for the decision logic may include: a) the extent of damage based on comparing the surface area of the damage versus the surface of the part affected, b) the localization of the damage on certain areas where the damage is considered critical leading to an escalation on the decision on how to restore the affected object (i.e. replacing instead of repairing), and/or c) the type of the damage which affects the labor hours needed to restore the damage in comparison with the overall cost of the affected part (in certain cases, it may be more cost effective to replace a part of the object rather than restore it manually with labor).

More particularly, the cost mapper 240 is an ensemble of processes that are applied to assess the cost of damage associated with the original input data (image). These processes leverage the output elements pertaining to the subcomponents of a decision logic matrix. The information from processes' output is synthesized and assembled into a vector, where each unique piece of output is represented as an element. This vector is used as input for trained ensemble pricing models (which, like some of the other processes of the systems 200, may be implemented. as neural networks) which generate floating point values as assessment costs for the remediation action (e.g., based on a dictionary of parts, and/or a dictionary of costs for parts). The cost mapper 240 may have the capability to also generate new and/or evolved metadata attributes. The input to the cost mapper 240 may thus include such information elements as the potential parts detected, the probability of parts being present, and/or metrics representing confidences in damages for the respective parts. At least some of the output produced by the cost mapper 240 may be used as input to submit a request to a database of regional labor cost. The database's response is used to provide the final estimated cost to repair (or replace) the object being analyzed.

The cost mapper 240 may include multiple processes (which may be executed in concert or independently), including:

1) A parts cost process 242 configured to determine the cost of an item to be replaced based on specific characteristics of the object under assessment. This process may allow integration and/or interaction with a database of parts associated with a set of relevant components to so that a reference point for an overall assessment cost can be determined.

2) A labor cost process 244 configured to compute the labor cost necessary to repair or replace items that have abnormalities. This process may allow for integration and/or interaction with a database of work hours associated with repairing and replacing different damages so that the number of work hours needed to repair or replace the damages found can be determined.

3) A finishing cost process 246 configured to determine the cost that is needed to finish the repair, e.g., paint cost and labor. This process also allows for integration and/or interaction with a database of surface finish descriptions associated with repairing different damages so as to allow the number of estimated work hours to be determined.

4) A waste cost process 248 configured to determine the cost of disposal of dangerous waste elements that are byproducts of the repair. This process allows for integration and/or interaction with a database of waste reclamation descriptions associated with repairing and replacing different damages to determine the waste impact of the materials and processes needed to repair the damages found in a claim.

5) A region cost adjustment process 250 configured to adjust cost estimates based on the locality in which remediation action is to be performed, e.g., based on country, region, sub-region, economic zone, etc. This process allows for integration and/or interaction with a database of labor rates, parts pricing and tax factors to adjust the cost of elements for specific countries, regions, and/or economic zones.

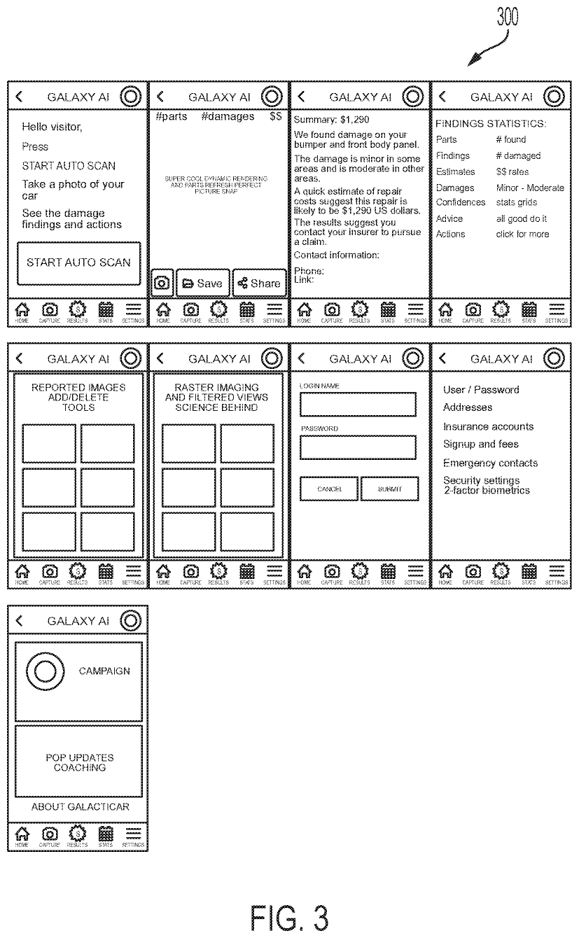

As further shown in FIG. 2, the system 200 may also include a report module 260 configured to generate an output report (e.g., vehicle repair appraisal). The report module 260 is implemented to send message transmissions to be received by an application server, and for that application server write to memory state for web services presentation. The web services presentation implements the data structures and field value representations generated by the report module 260 is implemented to, on the outbound side, expose the model as a database web services, and to present routes to queries of specific sub-model results and state. The report module 260 provides web service routes to JSON model representations of the findings resulting from processing performed by the system 200. The web services routes are URL pathnames that retrieve model data for specific condition findings. The condition findings include surface characteristics, bounding boxes around areas of interest, pixel gradient maps of surface conditions and data tag annotations. The model specific routes provide a real time dynamic feedback to an end device that is capturing and processing the surface image. The service route data is propagated to the end device for dynamic visualization and rendering of findings artifacts, and is implemented as an augmented reality feedback system. The augmented reality image overlay effects from query responses and continuous feed and augmented feedback loop reports findings updates on new images for an interactive user experience. FIG. 3 provides a view of example report generated by the system 200.

Thus, the system 200 illustrated in FIG. 2 is configured to implement filtering or masking of findings (features and probable semantic descriptions of such features) that aggregate as an interpretation truth in order to determine appropriate actions in relation thereto (e.g., to determine a corrective/mitigating action in response to detection of structural anomaly in the physical object under analysis). The collection of findings, including masked and aggregated findings, comprise a relevant set or “fingerprint” to the detection. The output generated by the various layers of the system 200 (or of the engine 130 of FIG. 1A) can be used, as an intermediary step or a conclusive step, for interference checking and for determination of feature overlap/non-overlap to derive detection confidence values associated with the masking/aggregating operations of the system. The system 200 (and/or the engine 130) allows the injection or integration of external data sources to facilitate in the analysis (e.g., for cost estimation) and establishment of criteria to generate findings outputs and reports. Criteria to generate finding and reports may be a sum of the average confidence level of the detection operations performed by the processes 220 to 226, which may be summarized as text by the observability code. Based on certain thresholds of the confidence levels the report can be created and the confidence level of the detections attached as an overall confidence on the accuracy of the findings contained in the report.

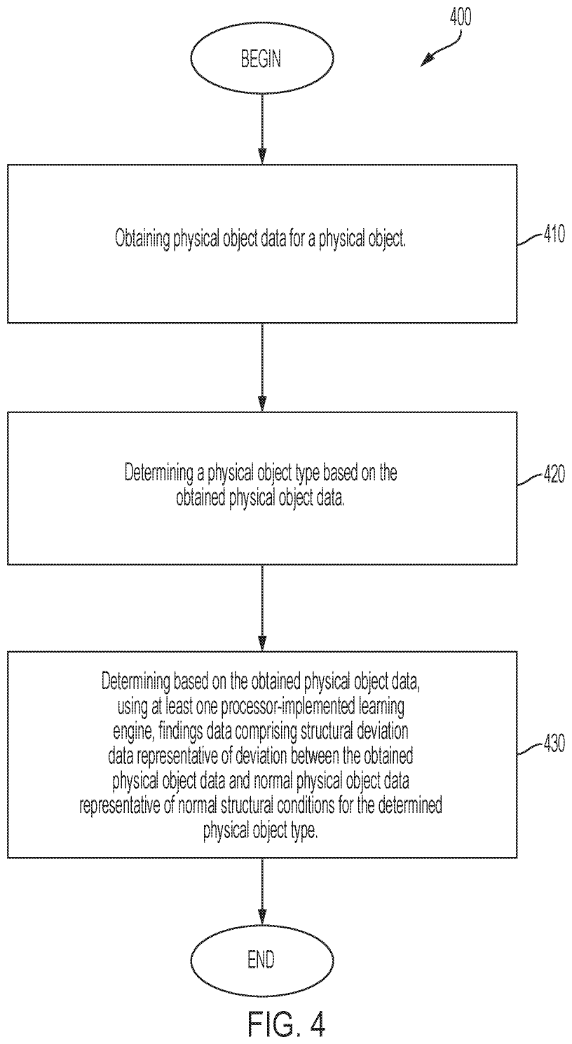

With reference next to FIG. 4, a flowchart of an example procedure 400 to determine structural anomalies for a physical object (such as a car) is shown. The procedure 400 includes obtaining 410 physical object data for a physical object. in some embodiments, obtaining the physical object may include capturing image data of the physical object with one or more cameras (such as the cameras 110a-n depicted in FIG. 1A) providing one or more distinctive views of the physical object.

Having obtained the physical object data, the procedure 400 further includes determining 420 a physical object type based on the obtained physical object data. In some situations, determining the physical object type may include identifying one or more features of the physical object from the obtained physical object data, and performing classification processing on the identified one or more features to select the physical object type from a dictionary of a plurality of object types. In embodiments in which obtaining physical object data includes capturing image data for the physical object, determining the physical object type may include identifying, based on the captured image data for the physical object, an image data type from a plurality of pre-determined image data types. Examples of the plurality of pre-determined image data types may include one or more of a location in which a vehicle is located, an exterior portion of the vehicle, an interior portion of the vehicle, and/or a vehicle identification number (VIN) for the vehicle.

As noted, the determination of the physical object type may be performed using the object identification process 220 of the system 200 depicted in FIG. 2. The identification of whether, and/or what type of object is present in a data set (e.g., in an image) may be performed based on learning engine/classifier processing in which the data is provided as input to a previously trained learning engine, and a determination is made of whether the data provided is sufficiently similar to previously processed training samples so that the learning engine produces an outcome consistent with a learned I trained outcome associated with the training samples. In some embodiments, determination of the object type may be based on identifying features of the object from the data, and matching those features to known features associated with a plurality of objects. For example, different objects, such as cars (or even specific car types and models), may have unique morphological features (e.g., surface contours) that can be used to determine the object type and/or other information (e.g., the distance from the object to image-capture device; if an object is determined to be a particular car model, the dimensions of that car model would be known, and therefore the image dimensions for that object can be used to derive the distance to the image-capture device). In some embodiments, objects may be provided with optical indicators or tags (e.g., barcode tags, QR tags, etc.) that identify the object type (and thus its characteristics, including structural characteristics). The capture images of a barcode or a QR tag can then be processed by a controller (implementing one or more of the processes illustrated in FIG. 2) to decode the data encoded into such visual codes. Other procedures to identify the object type (and thus identify the structural characteristics for that object, which in turn can be used to determine whether structural abnormalities are present) may be used.

With continued reference to FIG. 4, the procedure 400 further includes determining 430 based on the obtained physical object data, using at least one processor-implemented learning engine, findings data that includes structural deviation data representative of deviation (e.g., structural deviation) between the obtained physical object data and optimal physical object data representative of normal structural conditions for the determined physical object type.

In some embodiments, determining the physical object type may include segmenting, in response to determination that the physical object data corresponds to a captured image of a vehicle, associated image data from the captured image into one or more regions of interests and classifying the one or more regions of interest into respective one or more classes of vehicle parts. Segmenting the associated image data into the one or more regions of interest may include resizing the captured image to produce a resultant image with a smallest of sides of the captured image being set to a pre-assigned size, and other of the sides of the resultant image being re-sized to resultant sizes that maintain, with respect to the pre-assigned size, an aspect ratio associated with the captured image, transforming resultant image data for the re-sized resultant image, based on statistical characteristics of one or more training samples of a learning-engine classifier used to classify the one or more regions of interest, to normalized image data, and segmenting the normalized image data into the one or more regions of interest. Classifying the one or more regions of interest may include classifying, using the learning-engine classifier, the one or more regions of interest in the re-sized resultant image containing the normalized image data into the respective one or more classes of vehicle parts.

In some embodiments, determining the structural deviation between the captured physical object data and the normal physical object data may include detecting structural defects, using a structural defect learning-engine, for at least one of the segmented one or more regions of interest. Detecting the structural defects may include deriving structural defect data, for the structural defects detected for the at least one of the segmented one or more regions of interest, representative of a type of defect and a degree of severity of the defect.

In some embodiments, the procedure 400 may further include determining, based on the determined structural deviation data, hidden damage data representative of one or more hidden defects (e.g., inferring damage to the axel or chassis of a car) in the physical object not directly measurable from the captured physical object data. The hidden damage data for at least some of the one or more hidden defects may be associated with a confidence level value representative of the likelihood of existence of the respective one of the one or more hidden defects. In some variations, the procedure may further include deriving, based on the determined structural deviation, repair data representative of operations to transform the physical object to a state approximating the normal structural conditions for the determined object type. Deriving the repair data may include, in some examples, configuring a rule-driven decision logic process, and/or may include a data driven probabilistic models or deep learning network classification processes, to determine a repair or replace decision for the physical object based, at least in part, on ground truth output generated by an optimization process applied to at least some of the determined structural deviation. The optimization process comprises a stochastic gradient descent optimization process, or any other process that computes coefficients that best match a given set of constraints, optimization functions, and input and output values.

In some embodiments, the procedure 400 may further include generating feedback data based on the findings data, with the feedback data including guidance data used to guide (e.g., by way of control signals to actuate a device and/or sensors coupled to the device, or through audio-visual guidance provided to an operator/user) the collection of additional physical object data for the physical object. Generating the feedback data may include generating (e.g., by one or more processor-based devices), based on the findings data, synthetic data representative of information completeness levels for one or more portions of the physical object. For example, the processing-based device (which may implement learning engines, classifier, or other types of adaptive or non-adaptive analysis engines) may identify parts and features for an identified object (e.g., a vehicle), and further determine corresponding confidence levels associated with the identified features, components, detected structural anomalies (e.g., damaged parts, etc.) For identified. features or components exceeding some pre-determined confidence threshold, synthetic subject data (e.g., graphical objects, that include shapes, colors, shades, etc.) are generated, along with relative positional information for the synthetic subject data (to allow placement or rendering of graphical objects on an output interface device). The synthetic subject data object are communicated back to the device (or data acquisition module, in circumstance where the same device is used to acquire and analyze the data) controlling the data acquisition for the object being analyzed. The graphical objects can be rendered on a screen to form a synthetic representation of the object under analysis. Alternatively, the synthetic subject data can be overlaid on captured image(s) of the objects to graphically illustrate (for the benefit of an operator) regions where enough information has been collected, and regions where additional information is still required. Thus, in such embodiments, generating the synthetic subject data may include generating graphical data representative of information completeness levels for the one or more portions of the physical object, the graphical data configured to be rendered in an overlaid configuration on one or more captured images of the physical object to visually indicate the information completeness levels for the one or more portions of the physical object.

Based on the feedback data, a user can then manipulate the device and/or sensor device to obtain the additional data. Alternatively, the feedback data may include control signals to automatically actuate the device (e.g., to control displacement of the device) or the data acquisition sensors of the device). Thus, in such embodiments, the procedure may further include causing, based at least in part on the feedback data, actuation of a device comprising sensors to capture the additional physical object data for the physical object for at least one portion of the physical object for which a corresponding information completeness level is below a pre-determined. reference value.

Performing the various operations described herein may be facilitated by a controller system (e.g., a processor-based controller system). Particularly, at least some of the various devices/systems described herein, including any of the neural network devices, data acquisition devices (such as any of the cameras 110a-n), a remote server or device that performs at least some of the detection and/or analysis operations described herein (such as those described in relation to FIGS. 1-2 and 4), etc., may be implemented, at least in part, using one or more processor-based devices.

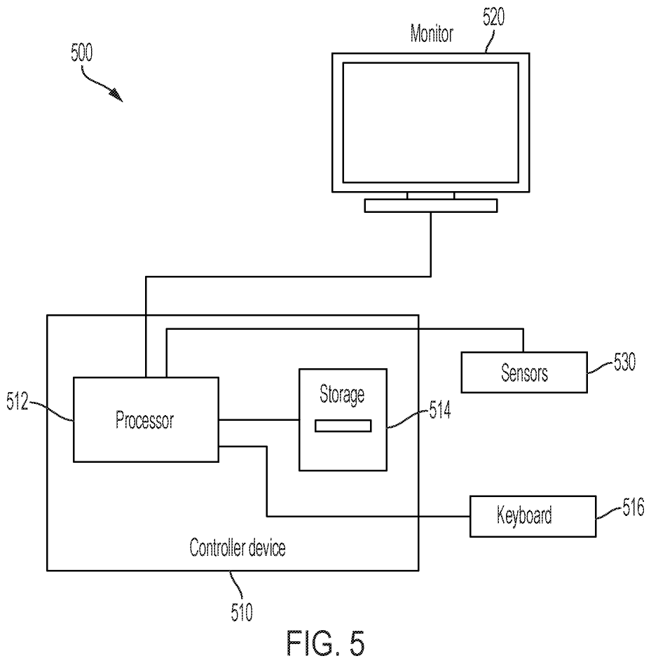

Thus, with reference to FIG. 5, a schematic diagram of a computing system 500 is shown. The computing system 500 includes a processor-based device (also referred to as a controller device) 510 such as a personal computer, a server, a specialized computing device, and so forth, that typically includes a central processor unit 512, or some other type of controller (or a plurality of such processor/controller units). In addition to the CPU 512, the system includes main memory, cache memory and bus interface circuits (not shown in FIG. 5). The processor-based device 510 may include a mass storage element 514, such as a hard drive (realize as magnetic discs, solid state (semiconductor) memory devices), flash drive associated with the computer system, etc. The computing system 500 may further include a keyboard 516, or keypad, or some other user input interface, and a monitor 520, e.g., an LCD (liquid crystal display) monitor, that may be placed where a user can access them. The computing system 500 may also include one or more sensors 530 (e.g., an image-capture device to obtain image data for observable features of objects in a scene, inertial sensors, environmental condition sensors, etc.) to obtain data to be analyzed (e.g., to determine existence of structural abnormalities associated with the observed objects).

The processor-based device 510 is configured to facilitate, for example, the implementation of feature detection for a physical object (such as vehicle), and the determination of deviations of the structural condition of the object from normal conditions, based on the procedures and operations described herein. The storage device 514 may thus include a computer program product that when executed on the processor-based device 510 causes the processor-based device to perform operations to facilitate the implementation of procedures and operations described herein. The processor-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver(s)), for downloading related content to the connected system. Such peripheral devices may also be used for downloading software containing computer instructions to enable general operation of the respective system/device. Alternatively or additionally, in some embodiments, special purpose logic circuitry, e.g., an FPGA (field programmable gate array), an ASIC (application-specific integrated circuit), a DSP processor, etc., may be used in the implementation of the system 500 in order to implement the learning engine including the neural networks. Other modules that may be included with the processor-based device 510 are speakers, a sound card, a pointing device, e.g., a mouse or a trackball, by which the user can provide input to the computing system 500. The processor-based device 510 may include an operating system, e.g., Windows XP® Microsoft Corporation operating system, Ubuntu operating system, etc.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory), electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAL, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
obtaining physical object data for a physical object;
determining a physical object type based on the obtained physical object data; and
determining based on the obtained physical object data, using at least one processor-implemented learning engine, findings data comprising structural deviation data representative of deviation between the obtained physical object data and normal physical object data representative of normal structural conditions for the determined physical object type.

2. The method of claim 1, wherein obtaining physical object data comprises capturing image data for the physical object, and wherein determining the physical object type comprises:
identifying, based on the captured image data for the physical object, an image data type from a plurality of pre-determined image data types.

3. The method of claim 2, wherein the plurality of pre-determined image data types comprises one or more: a location in which a vehicle is located, an exterior portion of the vehicle, an interior portion of the vehicle, or a vehicle identification number (VIN) for the vehicle.

4. The method of !lain) 1, wherein determining the physical object type comprises:
in response to determination that the physical object data corresponds to a captured image of a vehicle, segmenting associated image data from the captured image into one or more regions of interests and classifying the one or more regions of interest into respective one or more classes of vehicle parts.

5. The method of claim 4, wherein segmenting the associated image data into the one or more regions of interest comprises:
resizing the captured image to produce a resultant image with a smallest of sides of the captured image being set to a pre-assigned size, and other of the sides of the resultant image being re-sized to resultant sizes that maintain, with respect to the pre-assigned size, an aspect ratio associated with the captured image;
transforming resultant image data for the re-sized resultant image, based on statistical characteristics of one or more training samples of a learning-engine classifier used to classify the one or more regions of interest, to normalized image data; and
segmenting the normalized image data into the one or more regions of interest.

6. The method of claim 5, further comprising:
classifying, using the learning-engine classifier, the one or more regions of interest in the re-sized resultant image containing the normalized image data into the respective one or more classes of vehicle parts.

7. The method of claim 4, wherein determining the structural deviation data between the captured physical object data and the normal physical object data comprises:
detecting structural defects, using a structural defect learning-engine, for at least one of the segmented one or more regions of interest.

8. The method of claim 7, wherein detecting the structural defects comprises:
deriving structural defect data, for the structural defects detected for the at least one of the segmented one or more regions of interest, representative of a type of defect and a degree of severity of the defect.

9. The method of claim 1, further comprising:
determining, based on the determined structural deviation data, hidden damage data. representative of one or more hidden defects in the physical object not directly measurable from the captured physical object data, wherein the hidden damage data for at least some of the one or more hidden defects is associated with a confidence level value representative of the likelihood of existence of the respective one of the one or more hidden defects.

10. The method of claim 1, further comprising:
deriving, based on the determined structural deviation data, repair data representative of operations to transform the physical object to a state approximating the normal structural conditions for the determined object type.

11. The method of claim 10, wherein deriving the repair data comprises:
configuring a rule-driven decision logic process to determine a repair or replace decision for the physical object based, at least in part, on ground truth output generated by an optimization process applied to at least some of the determined structural deviation.

12. The method of claim 11, wherein the optimization process comprises a stochastic gradient descent optimization process.

13. The method of claim 1, wherein obtaining h physical object data for the physical object comprises:
capturing image data of the physical object with one or more cameras providing one or more distinctive views of the physical object.

14. The method of claim 1, wherein determining the physical object type comprises:
identifying one or more features of the physical object from the obtained physical object data; and
performing classification processing on the identified one or more features to select the physical object type from a dictionary of a plurality of object types.

15. The method of claim 1, further comprising:
generating feedback data based on the findings data, the feedback data comprising guidance data used to guide the collection of additional physical object data for the physical object.

16. The method of claim 15, wherein generating the feedback data comprises:
generating, based on the findings data, synthetic subject data representative of information completeness levels for one or more portions of the physical object.

17. The method of claim 16, wherein generating the synthetic subject data comprises:
generating graphical data representative of information completeness levels for the one or more portions of the physical object, the graphical data configured to be rendered in an overlaid configuration on one or more captured images of the physical object to visually indicate the information completeness levels for the one or more portions of the physical object.

18. The method of claim 15, further comprising:
causing, based at least in part on the feedback data, actuation of a device comprising sensors to capture the additional physical object data for the physical object for at least one portion of the physical object for which a corresponding information completeness level is below a pre-determined reference value.

19. A system comprising:
an input stage to obtain physical object data for a physical object from one or more data acquisition devices;
a controller, implementing one or more learning engines, in communication with a mem ice to store programmable instructions, to:
determine a physical object type based on the obtained physical object data; and
determine based on the obtained physical object data, using at least one of the one or more learning engines, findings data comprising structural deviation data representative of deviation between the obtained physical object data and normal physical object data representative of normal structural conditions for the determined physical object type.

20. The system of claim 19, further comprising the one or more data acquisition devices, wherein the one or more data acquisition devices comprise one or more image capture devices to capture image data for the physical object, and wherein the controller configured to determine the physical object type is configured to:
identify, based on the captured image data the physical object, an image data type from a plurality of pre-determined image data types.

21. The system of claim 19, wherein the controller configured to determine .e physical object type is configured to:
segment, in response to determination that the physical object data corresponds to a captured image of a vehicle, associated image data from the captured image into one or more regions of interests and classifying the one or more regions of interest into respective one or more classes of vehicle parts.

22. The system of claim 19, herein the controller is further configured to:
derive, based on the determined structural deviation data, repair data representative of operations to transform the physical object to a state approximating the normal structural conditions for the determined object type.

23. The system of claim 22, wherein the controller configured to derive the repair data is configured to:
configure a rule-driven decision logic process to determine a repair or replace decision for the physical object based, at least in part, on ground truth output generated by an optimization process applied to at least some of the determined structural deviation data.

24. The system of claim 19, wherein the controller is further configured to:
generate feedback data based on the findings data, the feedback data comprising guidance data used to guide the collection of additional physical object data for the physical object.

25. The system of claim 24, wherein the controller configured to generate the feedback data is configured to:
generate, based on the findings data, synthetic subject data representative of information completeness levels for one or more portions of the physical object.

76. The system of claim 25, wherein the controller configured to generate the synthetic subject data is configured to:
generate graphical data representative of information completeness levels for the one or more portions of the physical object, the graphical data configured to be rendered in an overlaid configuration on one or more captured images of the physical object to visually indicate the information completeness levels for the one or more portions of the physical object.

27. The system of claim 24, wherein the controller is further configured to:
cause, based at least in part on the feedback data, actuation of a device comprising sensors to capture the additional physical object data for the physical object for at least one portion of the physical object for which a corresponding information completeness level is e a pre-determined reference value.

28. A non-transitory computer readable media storing a set of instructions, executable on at least one programmable device, to:
obtain physical object data for a physical object;
determine a physical object type based on the obtained physical object data; and
determine based on the obtained physical object data, using at least one processor-implemented learning engine, findings data comprising structural deviation data representative of deviation between the obtained physical object data and normal physical object data representative of normal structural conditions for the determined physical object type.
